(19) United States
(12) Patent Application Publication
(10) Pub. No.: US 2010/0149206 A1
(43) Pub. Date: Jun. 17, 2010

(54) DATA DISTRIBUTION SYSTEM, DATA DISTRIBUTION APPARATUS, DATA DISTRIBUTION METHOD AND RECORDING MEDIUM, IMPROVING USER CONVENIENCE

(75) Inventors: Kei Shigehisa, Amagasaki-shi (JP); Takeshi Morikawa, Takarazuka-shi (JP); Kenji Matsuhara, Kawanishi-shi (JP); Toshimichi Iwai, Kitakatsuragi-gun (JP)

Correspondence Address: MORRISON & FOERSTER LLP, 1650 TYSONS BOULEVARD, SUITE 400, MCLEAN, VA, 22102, US

(73) Assignee: Konica Minolta Business Technologies, Inc., Tokyo (JP)

(21) Appl. No.: 12/638,638

(22) Filed: Dec. 15, 2009

(30) Foreign Application Priority Data
Dec. 16, 2008 (JP) 2008-319830

(51) Int. Cl. G09G 5/02; G06F 3/041; G09G 5/00; H04N 7/18; G06F 3/033; G06K 9/00

(52) U.S. Cl. 345/595; 345/173; 345/629; 348/143; 345/619; 345/179; 382/189

(57) ABSTRACT

A CPU determines whether there is handwriting. If handwriting is determined to be done, the handwritten image data is obtained. Thereafter, CPU determines, based on the obtained handwritten image data, whether the handwritten image is a handwritten data for area designation. If it is determined, based on the obtained handwritten image data, that the handwritten image data is a handwritten image for area designation, next, a designated write area display process is executed.

This application is based on Japanese Patent Application No. 2008-319830 filed with the Japan Patent Office on Dec. 16, 2008, the entire content of which is hereby incorporated by reference.

### BACKGROUND OF THE INVENTION

1. Field of the Invention

The present invention relates to a data distribution system, a data distribution apparatus, a data distribution method and a data distribution program and, more specifically, to a data distribution system including a display device or the like for displaying distribution data and a data distribution apparatus, a data distribution apparatus, a data distribution method executed by the data distribution apparatus, and to a data distributing program.

2. Description of the Related Art

Along with recent multi-media development, displays having large screens come to be utilized at various scenes. By way of example, large-screen display devices, on which various images of documents and materials are displayed, come to be used widely at company conferences and the like.

Particularly, for a company conference, a display device having a whiteboard function has come to be generally used, in which not only images but also information drawn by a presenter on the large-screen display device using a so-called digitizer are displayed as the conference proceeds.

Further, various systems, in which images are displayed on a whiteboard using a projector or the like and contents handwritten on the whiteboard by a presenter of the presentation and the image data projected by the projector on the whiteboard are combined, have been proposed.

By way of example, Japanese Laid-Open Patent Publication Nos. 2001-016384 and 2007-102055 propose a method in which image data is projected on a whiteboard portion (whiteboard) using a projector, a handwritten image written by a user on the whiteboard portion is read and converted to electronic handwritten image data, and the thus converted data is combined with the image data projected on the whiteboard portion.

Japanese Laid-Open Patent Publication No. 2006-108813 proposes a method in which handwritten image data written on the whiteboard is obtained using a digital camera and combined with original document data projected on the whiteboard.

Japanese Laid-Open Patent Publication No. 2004-336289 proposes a method of managing history of handwritten image data written on the whiteboard.

Japanese Laid-Open Patent Publication No. 2005-195617 proposes a method in which not only the handwritten image data corresponding to the image data projected on a screen but also audio data is obtained, and the audio data is recorded and reproduced in association with the handwritten image data.

Japanese Laid-Open Patent Publication No. 2007-017543 proposes a method of combining image data projected on a whiteboard and handwritten image data representing a drawn image, without causing positional deviation.

In the apparatuses and systems described in the patent publications mentioned above, when image data, which is distribution data, for example, is displayed on a whiteboard, a method of combining the displayed image data and the input handwritten image data is disclosed. If the distribution data is displayed on the entire area of the whiteboard and handwriting is done on the whiteboard, it is possible that the handwritten contents become unclear because the contents overlap with the displayed distribution data.

Further, it is possible that there is no space for handwriting, or the handwriting must be done on a small space at a corner area. Specifically, due to space limitation, it is sometimes difficult to execute handwriting at an appropriate position.

In order to avoid such a problem, it has been necessary to stop display of the distribution data on the whiteboard or the like, ensure a space for handwriting and thereafter to execute handwriting.

### SUMMARY OF THE INVENTION

The present invention was made to solve the above-described problems and its object is to provide a data distribution system, a data distribution apparatus, a data distribution method, and a data distribution program that ensure an area for executing handwriting to improve user convenience, when distribution data is displayed on a display device or a projection board such as a whiteboard.

According to an aspect, the present invention provides a data distribution system, including: a data distribution apparatus outputting distribution data; and a display device displaying the distribution data output from the data distribution apparatus. The data distribution apparatus includes an input device receiving coordinate data input corresponding to a designated position of input, in a display area of the display device, and a controller configured to control the data distribution apparatus for i) outputting first handwritten image data to the display device such that based on the coordinate data of which input is received by the input device, the handwritten image is displayed in the display area of the display device, ii) determining whether a partial area in the display area of the display device is designated, based on the first handwritten image data, and iii) if it is determined that partial area in the display area of the display device is designated, editing the distribution data to ensure the designated partial area as a handwriting area, and outputs the data to the display device.

According to another aspect, the present invention provides a data distribution apparatus for outputting distribution data to be displayed on a display device, including: an input device receiving coordinate data input corresponding to a designated position of input, in a display area of the display device, and a controller configured to control the data distribution apparatus for i) outputting first handwritten image data to the display device such that based on the coordinate data of which input is received by the input device, the handwritten image is displayed in the display area of the display device, ii) determining whether a partial area in the display area of the display device is designated, based on the first handwritten image data, and iii) if it is determined that partial area in the display area of the display device is designated, editing the distribution data to ensure the designated partial area as a handwriting area, and outputs the data to the display device.

Preferably, the controller determines whether the first handwritten image data is data representing an area surrounded by a handwritten line in the display area of the display device.

Specifically, if it is determined that the first handwritten image data is data representing an area surrounded by a handwritten line in the display area of the display device, the controller edits the distribution data to have inside or outside of the area surrounded by the handwritten line as handwriting area image data, and outputs to the display device.

Preferably, the controller determines whether the first handwritten image data is data representing a plurality of points surrounding an area in the display area of the display device.

Specifically, if it is determined that the first handwritten image data is data representing a plurality of points surrounding an area in the display area of the display device, the controller edits the distribution data to have inside or outside of the area surrounded by the plurality of points as handwriting area image data, and outputs to the display device.

Preferably, the display device is provided with a touch panel. The input device receives input of coordinate data corresponding to a designated position of input from the touch panel.

Preferably, if it is determined that a partial area in the display area of the display device is designated, based on the first handwritten image data, the controller displays in advance an image to be displayed on the display device after editing of the distribution data, on an operation window.

Preferably, the controller performs a combining process of combining the distribution data with handwriting area image data in which nothing is displayed in the designated partial area in the display area of the display device, and outputs combined data to the display device.

Preferably, the controller performs a combining process of combining the distribution data with handwriting area image data in which the designated partial area in the display area of the display device becomes an area of a prescribed color, and outputs combined data to the display device.

Preferably, the controller reduces and outputs to the display device the distribution data such that the data is contained in an area outside the designated partial area in the display area of the display device.

Preferably, the controller displays on an operation window a candidate selection image allowing selection from a preset plurality of handwriting area image data, receives an input to select one of the plurality of handwriting area image data displayed on the candidate selection image, and performs a combining process of combining the distribution data with the selected handwriting area image data and outputs combined data to the display device.

Preferably, the controller combines the distribution data with second handwritten image data such that the handwritten image is displayed in the handwriting area ensured in the display device.

Specifically, the controller performs a combining process such that the second handwritten image data is displayed in the designated partial area in the display area of the display device and the distribution data reduced in size is displayed in an area outside of the designated partial area.

Specifically, the controller performs a combining process such that the second handwritten image data is displayed in the designated partial area in the display area of the display device, and, of the distribution data displayed in the display area of the display device, the distribution data corresponding to an area outside of the designated partial area is displayed.

Specifically, the distribution data consists of a plurality of page data separated page by page and distributed in turn. The controller performs the combining process of combining the page data with the second handwritten image data.

Specifically, the distribution data consists of a plurality of page data separated page by page and distributed in turn. The controller performs the combining process of combining the page data with the second handwritten image data, in response to an instruction to switch page data to be distributed.

Specifically, if it is determined that after the second handwritten image data is output, there is no handwriting made to the handwriting area ensured in the display device for a prescribed time period, the controller performs a combining process of combining the distribution data with the second handwritten image data.

According to a further aspect, the present invention provides a data distribution system, including: a data distribution apparatus outputting distribution data; a projector device projecting the distribution data output from the distribution apparatus to a screen; and an image pick-up device obtaining an image displayed on the screen. The data distribution apparatus includes a controller configured to control the data distribution apparatus for i) extracting, based on an image obtained by picking-up the image displayed on the screen by the image pick-up device, an image handwritten to the screen included in an area projected to the screen, ii) determining, based on the extracted handwritten image data written to the screen, whether a partial area of the distribution data projected on the screen is designated, and iii) if it is determined that a partial area of the distribution data projected on the screen is designated, editing the distribution data and outputs to the projector device, to ensure the designated partial area as a handwriting area.

According to a still further aspect, the present invention provides a data distribution apparatus outputting distribution data to be projected on a screen to a projector device, including a controller configured to control the data distribution apparatus for i) extracting, based on an image obtained by picking-up the image displayed on the screen, an image handwritten to the screen included in an area projected to the screen as a first handwritten image, ii) determining, based on the extracted first handwritten image data written to the screen, whether a partial area of the distribution data projected on the screen is designated, and iii) if it is determined that a partial area of the distribution data projected on the screen is designated, editing the distribution data and outputs to the projector device, to ensure the designated partial area as a handwriting area.

Preferably, the controller determines whether the first handwritten image data represents an area surrounded by a handwritten line.

Specifically, if it is determined that the first handwritten image data is data representing an area surrounded by a handwritten line in an area of the screen on which the distribution data is projected, the controller edits the distribution data to have inside or outside of the area surrounded by the handwritten line as handwriting area image data, and outputs to the projector device.

Preferably, the controller determines whether the first handwritten image data is data representing a plurality of points surrounding an area in the area of the screen on which the distribution data is projected.

Specifically, if it is determined that the first handwritten image data is data representing a plurality of points surrounding an area in the area of the screen on which the distribution data is projected, the controller edits the distribution data to have inside or outside of the area surrounded by the plurality of points as handwriting area image data, and outputs to the projector device.

Preferably, the data distribution apparatus receives as an input an image obtained by a camera or a scanner.

Preferably, if it is determined that the partial area is designated, the controller displays in advance an image to be projected to the screen by the projector device after editing of the distribution data, on an operation window.

Preferably, the controller performs a combining process of combining the distribution data with handwriting area image data in which nothing is displayed in the designated partial area in the area of the screen on which the distribution data is projected, and outputs combined data to the display device.

Preferably, the controller performs a combining process of combining the distribution data with a handwriting area image data in which the designated partial area in the area of the screen on which the distribution data is projected becomes an area of a prescribed color, and outputs combined data to the display device.

Specifically, the area of a prescribed color has the same color as the screen.

Preferably, the controller reduces and outputs to the display device the distribution data such that the data is contained in an area outside the designated partial area in the area of the screen on which the distribution data is projected.

Preferably, the controller displays on an operation window a candidate selection image allowing selection from a preset plurality of handwriting area image data, receives an input to select one of the plurality of handwriting area image data displayed on the candidate selection image, and performs a combining process of combining the distribution data with the selected handwriting area image data and outputs combined data to the projector device.

Preferably, after the handwriting area is ensured on the screen, the data distribution apparatus receives as an input another image obtained by picking-up an image displayed on the screen. The controller extracts, based on the other obtained image, an image handwritten to the handwriting area of the screen, and combines the distribution data with second handwritten image data written to the extracted handwriting area of the screen.

Specifically, the controller performs a combining process such that the second handwritten image data is displayed in the designated partial area and the distribution data reduced in size is displayed in an area outside of the designated partial area.

Specifically, the controller performs a combining process such that the second handwritten image data is displayed in the designated partial area, and, of the distribution data displayed in the display area of the display device, the distribution data corresponding to an area outside of the designated partial area is displayed.

Specifically, the distribution data consists of a plurality of page data separated page by page and distributed in turn. The controller performs the combining process of combining the page data with the extracted second handwritten image data.

Specifically, the distribution data consists of a plurality of page data separated page by page and distributed in turn. The controller performs the combining process of combining the page data with the extracted second handwritten image data, in response to an instruction to switch page data to be distributed.

Specifically, if it is determined that after the second handwritten image data written to the screen is extracted, there is no extraction of another handwritten image data written to the handwriting area for a prescribed time period, the controller performs a combining process for combining the distribution data with the second handwritten image data.

Specifically, based on another obtained image, the controller recognizes a person's hand performing a handwriting, in a range of image pickup between the projector device and the screen, and if a person's hand is recognized, the controller combines the distribution data with the second handwritten image data written to the handwriting area of the screen.

Preferably, the controller further controls an erasure device for erasing an image handwritten to the screen, provided on the screen.

Specifically, the distribution data consists of a plurality of page data separated page by page and distributed in turn. The controller instructs the erasure device to erase an image handwritten to the screen in response to an instruction to switch page data to be distributed.

According to a still further aspect, the present invention provides a data distribution method of distributing data to be displayed to a display device, including the steps of: receiving coordinate data input corresponding to a designated position of input, in a display area of the display device; outputting first handwritten image data to the display device such that based on the coordinate data of which input is received, the handwritten image is displayed in the display area of the display device; determining whether a partial area in the display area of the display device is designated, based on the first handwritten image data; and if it is determined at the determining step that partial area in the display area of the display device is designated, editing the distribution data to ensure the designated partial area as a handwriting area, and outputting the data to the display device.

According to a still further aspect, the present invention provides a recording medium recording a data distribution program to be executed by a computer of a data distribution apparatus outputting distribution data to be displayed on a display device, the data distribution program causing the computer to execute the steps of: receiving coordinate data input corresponding to a designated position of input, in a display area of the display device; outputting first handwritten image data to the display device such that based on the coordinate data of which input is received, the handwritten image is displayed in the display area of the display device; determining whether a partial area in the display area of the display device is designated, based on the first handwritten image data; and if it is determined at the determining step that partial area in the display area of the display device is designated, editing the distribution data to ensure the designated partial area as a handwriting area, and outputting the data to the display device.

According to a still further aspect, the present invention provides a data distribution method of distributing data to be projected on a screen to a projector device, including the steps of: extracting, based on an image obtained by picking-up the image displayed on the screen, an image handwritten to the screen included in an area projected to the screen; determining, based on the extracted handwritten image data written to the screen, whether a partial area of the distribution data projected on the screen is designated; and if it is determined at the determining step that a partial area of the distribution data projected on the screen is designated, editing the distribution data and outputting to the projector device, to ensure the designated partial area as a handwriting area.

According to a still further aspect, the present invention provides a recording medium recording a data distribution program to be executed by a computer of a data distribution apparatus outputting distribution data to be projected on a screen to a projector device, the data distribution program causing the computer to execute the steps of: extracting, based on an image obtained by picking-up the image displayed on the screen, an image handwritten to the screen included in an area projected to the screen; determining, based on the extracted handwritten image data written to the screen, whether a partial area of the distribution data projected on the screen is designated; and if it is determined at the determining step that a partial area of the distribution data projected on the screen is designated, editing the distribution data and outputting to the projector device, to ensure the designated partial area as a handwriting area.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 shows a conference system (data distribution system) in accordance with Embodiment 1 of the present invention.

FIG. 2 is a schematic block diagram showing configurations of an MFP and a display device in the conference system in accordance with Embodiment 1 of the present invention.

FIG. 3 shows a box selection window when a box button is selected.

FIG. 4 shows a conference file selection window when a conference box button is pressed in the state shown in FIG. 3.

FIG. 5 shows a conference file process selection window.

FIG. 6 is a flowchart representing activation of a box (BOX) distribution process in the MFP in accordance with Embodiment 1 of the present invention.

FIG. 7 is a flowchart representing a box distribution process in accordance with Embodiment 1 of the present invention.

FIG. 8 shows a first image displayed on a display area of the display device in accordance with Embodiment 1 of the present invention.

FIG. 9 shows a second image displayed on a display area of the display device in accordance with Embodiment 1 of the present invention.

FIG. 10 shows a third image displayed on a display area of the display device in accordance with Embodiment 1 of the present invention.

FIG. 11 is a flowchart representing a designated write area display process in accordance with Embodiment 1 of the present invention.

FIG. 12 illustrates a designated write area confirmation window.

FIG. 13 shows a write area pattern list display confirmation window in accordance with Embodiment 1 of the present invention.

FIG. 14 illustrates combined data obtained by processing and editing the original image data in which the designated write area is ensured, in accordance with Embodiment 1 of the present invention.

FIG. 15 shows a write area pattern list window in accordance with Embodiment 1 of the present invention.

FIG. 16 illustrates an example in which the original image data is combined with the selected write area pattern in the designated write area, in accordance with Embodiment 1 of the present invention.

FIG. 17 illustrates an example in which handwritten image data obtained by executing handwriting to the designated write area is combined to the original image data (distribution data) and saved in BOX of the MFP, in accordance with Embodiment 1 of the present invention.

FIG. 18 is a flowchart representing handwriting combining process in accordance with Embodiment 1 of the present invention.

FIG. 19 shows a window for various settings in accordance with Embodiment 1 of the present invention.

FIG. 20 is a flowchart representing a combining process in accordance with Embodiment 1 of the present invention.

FIG. 21 illustrates an example in which the handwritten image data is combined with original image data in accordance with Embodiment 1 of the present invention.

FIG. 22 is a flowchart representing a saving process in accordance with Embodiment 1 of the present invention.

FIG. 23 illustrates a process of page addition saving in accordance with Embodiment 1 of the present invention.

FIG. 24 is a flowchart representing an erasure process in accordance with Embodiment 1 of the present invention.

FIG. 25 is a schematic diagram showing a conference system (data distribution system) in accordance with Embodiment 2 of the present invention.

FIG. 26 is a flowchart representing a box distribution process in accordance with Embodiment 2 of the present invention.

FIG. 27 is a flowchart representing a designated write area display process in accordance with Embodiment 2 of the present invention.

FIG. 28 is a flowchart representing handwriting combining process in accordance with Embodiment 2 of the present invention.

FIG. 29 shows a window for various settings in accordance with Embodiment 2 of the present invention.

### DESCRIPTION OF THE PREFERRED EMBODIMENTS

In the following, Embodiment 1 of the present invention will be described with reference to the figures. In the following description, the same components and elements are denoted by the same reference characters. Their names and functions are also the same.

### Embodiment 1

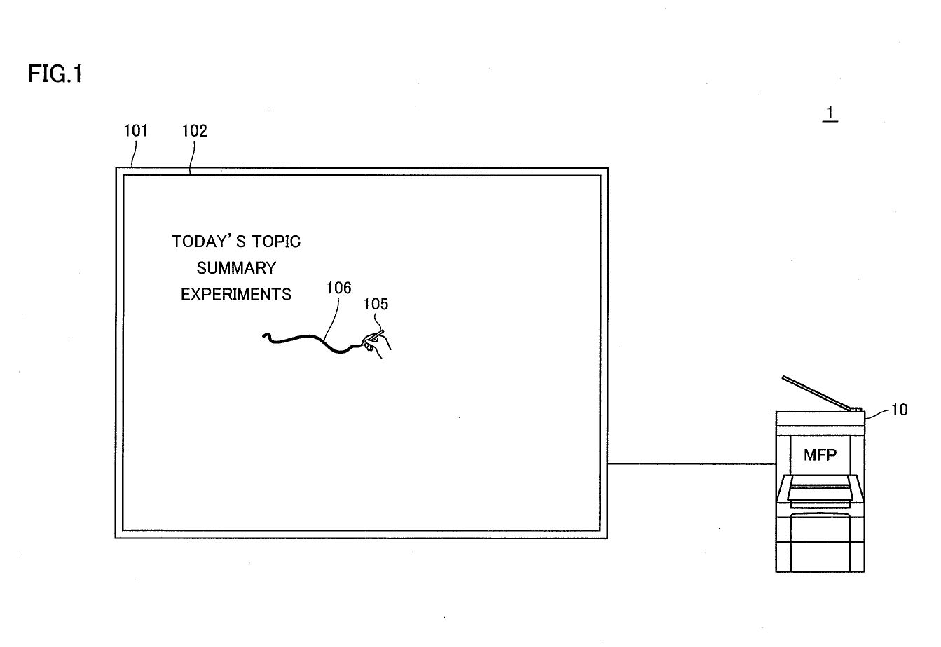

A conference system (data distribution system) in accordance with Embodiment 1 of the present invention will be described, with reference to FIG. 1.

Referring to FIG. 1, a conference system 1 in accordance with Embodiment 1 of the present invention includes an MFP (Multi Function Peripheral) 10 and a display device 101. MFP 10 is a multi-functional digital peripheral having the functions of copying, printer, facsimile and the like.

In conference system 1 in accordance with Embodiment 1 of the present invention, MFP 10 and display device 101 are connected to each other, distribution data stored in MFP 10 is output to display device 101 and the distribution data is displayed on a display area 102 of display device 101. Specifically, MFP 1 serves as a data distribution apparatus.

Though not shown, a touch panel is provided on display device 101, and based on coordinate data designated by a touch pen 105, it is possible to execute a drawing operation on display area 102 of display device 101 in accordance with the touched track of touch pen 105.

Specifically, using a CPU of MFP 10, whiteboard software is activated and by the whiteboard function, the drawing operation (handwriting) can be executed, as will be described later.

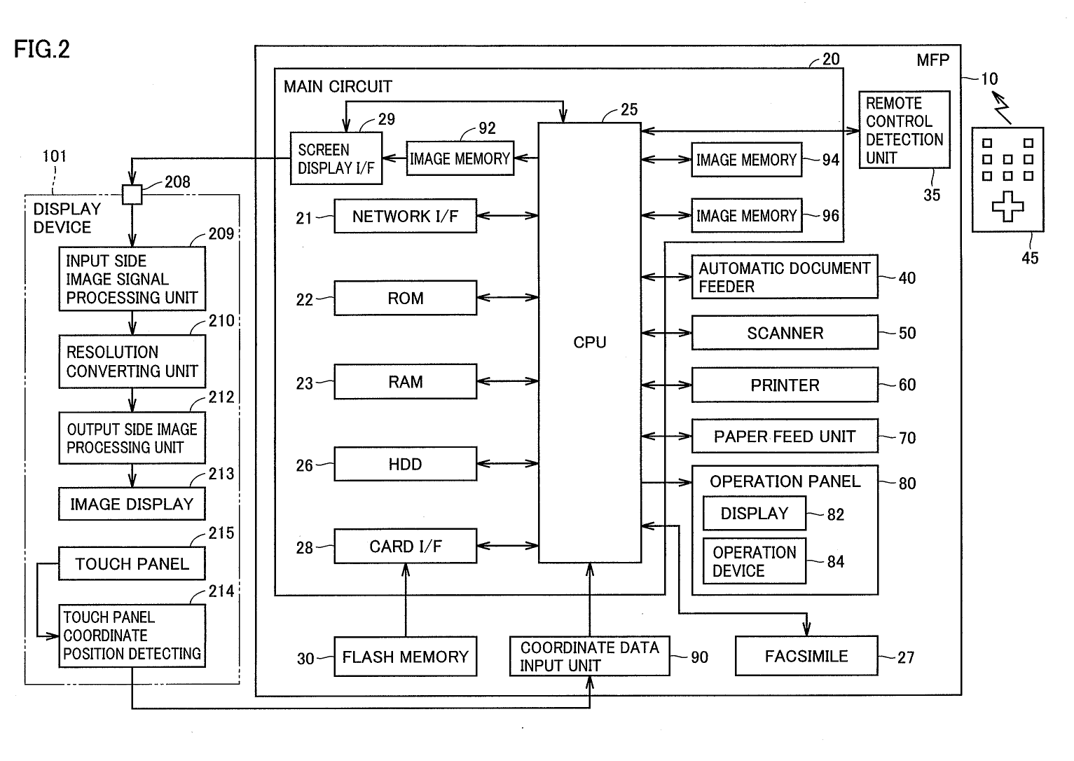

Schematic block configurations of MFP 10 and display device 101 in conference system 1 of Embodiment 1 in accordance with the present invention will be described, with reference to FIG. 2.

Referring to FIG. 2, MFP 10 in accordance with Embodiment 1 outputs distribution data stored therein to display device 101.

Display device 101 includes an image input terminal 208, an input side image signal processing unit 209, a resolution converting unit 210, an output side image processing unit 212, an image display 213, a touch panel 215, and touch panel coordinate position detecting unit 214.

If the input signal (image data) input through image input terminal 208 is an analog signal, input side image signal processing unit 209 performs, on the input image signal, prescribed amplitude and DC level adjustments and conversion to a digital signal, and if the input signal is a digital signal, it executes signal processing such as conversion to a prescribed signal level or conversion to a color format.

Resolution converting unit 210 executes conversion of frame rate, resolution and the like of the image signal that has been processed by the input side image signal processing unit.

Output side image processing unit 212 executes signal processing including gamma processing and divided drive, suitable for a device that implements image display 213.

Image display 213 is formed of a device such as a liquid crystal display, a CRT (Cathode Ray Tube) or a plasma display panel (PDP), a driving circuit thereof, a light source and an emission optical system.

Touch panel 215 is arranged in correspondence with display area 102 of display device 101 and, by way of example, a resistive film type touch panel is used. It is noted, however, that touch panel 215 is not limited to the resistive type one, and an arbitrary pressure-sensitive type touch panel may be used.

Touch panel coordinate position detecting unit 214 detects coordinate positions on the touch panel provided on display area 102 of display device 101, and outputs coordinate data to MFP 10.

The coordinate data is output to coordinate data input unit of MFP 10.

Next, the schematic block diagram of MFP 10 will be described.

MFP 10 in accordance with Embodiment 1 of the present invention includes a main circuit 20, an automatic document feeder 40, a scanner 50, a printer 60, a paper feed unit 70, an operation panel 80, a facsimile 27, coordinate data input unit 90, and a remote control detecting unit 35. MFP 10 has a remote controller 45, and separate from operation panel 80, execution of prescribed functions can be instructed by an operation of remote controller 45.

Main circuit 20 includes: a CPU (Central Processing Unit) 25; a network interface (I/F) 21 for executing data exchange to/from an LAN, not shown; an ROM (Read Only Memory) 22 storing various software programs for executing prescribed functions of MFP 10; an RAM (Random Access Memory) 23 used, for example, as a work area of CPU 25; an HDD (Hard Disk Drive) 26 as a large capacity storage; a card interface (I/F) 28 connected to a flash memory 30 as an external storage, for executing data exchange to/from the memory; a screen display I/F 29 outputting distribution data and the like to image input terminal 208 of display device 101; and image memories 92, 94 and 96.

CPU 25 is connected to network I/F 21, ROM 22, RAM 23, HDD 26, card I/F 28 and screen display I/F 29, as well as to image memories 92, 94 and 96, for overall control of main circuit 20. It is assumed that the distribution data distributed in the conference system in accordance with the present embodiment are stored in advance in HDD 26.

Automatic document feeder 40 feeds documents placed on a platen, not shown, of MFP 10 one by one successively to scanner 50.

Scanner 50 optically reads image information of photographs, characters, pictures and the like from the documents fed by automatic document feeder 40 and obtains image data.

Printer 60 forms a color image using toners of four colors, that is, cyan, magenta, yellow and black, or a monochrome image, using any one of cyan, magenta, yellow and black toners.

Paper feed unit 70 stores sheets of paper, and feeds the stored sheets one by one to printer 60.

Operation panel 80 includes a display 82 and an operation device 84.

Display 82 is a display such as a liquid crystal display (LCD) or an organic ELD (Electro Luminescence Display), which displays instruction menu for the user, information related to obtained image data and the like. Operation device 84 includes a plurality of keys, and receives various instructions and data inputs of characters, numbers and the like by the user operation corresponding to the key operation. Operation device 84 includes a touch panel provided on display 82. Display 82 and operation device 84 constitute operation panel 80. Though not shown, it is assumed that a box button is provided on operation device 84, which allows an access to data stored in HDD 26. On operation device 84 of the operation panel, while the distribution data distributing process is being executed, though not shown, a switch instruction button instructing page switching of distribution data, which will be describe later, is provided. The switch instruction button may be provided on remote controller 45. Further, on operation device 84 of the operation panel, while the distribution data distributing process is being executed, though not shown, a combination button instructing execution of a process for combining handwriting, which will be described later, is provided. The combination button may be provided on remote controller 45. Further, on operation device 84 of the operation panel, while the distribution data distributing process is being executed, though not shown, an erasure button instructing execution of a process for erasing handwriting, which will be described later, is provided. The erasure button may be provided on remote controller 45.

Facsimile 27 is connected to a public switched telephone network (PSTN), and transmits facsimile data, and receives facsimile data from PSTN. The facsimile data received by facsimile 27 is stored by CPU 25 in HDD 26. Further, printer 60 prints the facsimile data stored in HDD 26 on a sheet of paper in accordance with an instruction from CPU 25.

Coordinate data input unit 90 receives input of coordinate data from touch panel coordinate position detecting unit 214 of display device 101, and outputs the data to CPU 25.

Remote control detecting unit 35 receives an operation signal from external remote controller 45, and outputs an instruction corresponding to the operation signal to CPU 25.

CPU 25 is connected to automatic document feeder 40, scanner 50, printer 60, paper feed unit 70, operation panel 80, facsimile 27 and remote control detecting unit 35, and controls MFP 10 as a whole.

Further, in the data distribution system in accordance with Embodiment 1 of the present invention, MFP 10 and display device 101 realize the whiteboard function for executing handwriting to display device 101. Specifically, by activating the whiteboard software stored in ROM 22 by CPU 25, the whiteboard function is executed. In that case, the distribution data stored in HDD 26 is once stored in image memory 94. Further, the handwritten image data that has been written as input displayed on display device 101 by the whiteboard function is stored in image memory 96. CPU 25 combines the distribution data stored in image memory 94 with the handwritten image data stored in image memory 96 and outputs the result to image memory 92. The combined data stored in image memory 92 is output through screen display IN 29 to display device 101.

Next, the process for distributing data in MFP 10 will be described.

As described above, in the present embodiment, it is assumed that the distribution data in the conference system in accordance with Embodiment 1 of the present invention is stored in HDD 26 of MFP 10, as an example.

As described above, there is a box button provided on operation device 84 allowing an access to HDD 26, and by selecting the box button, a selection window or the like for an access to the data stored in HDD 26 is displayed.

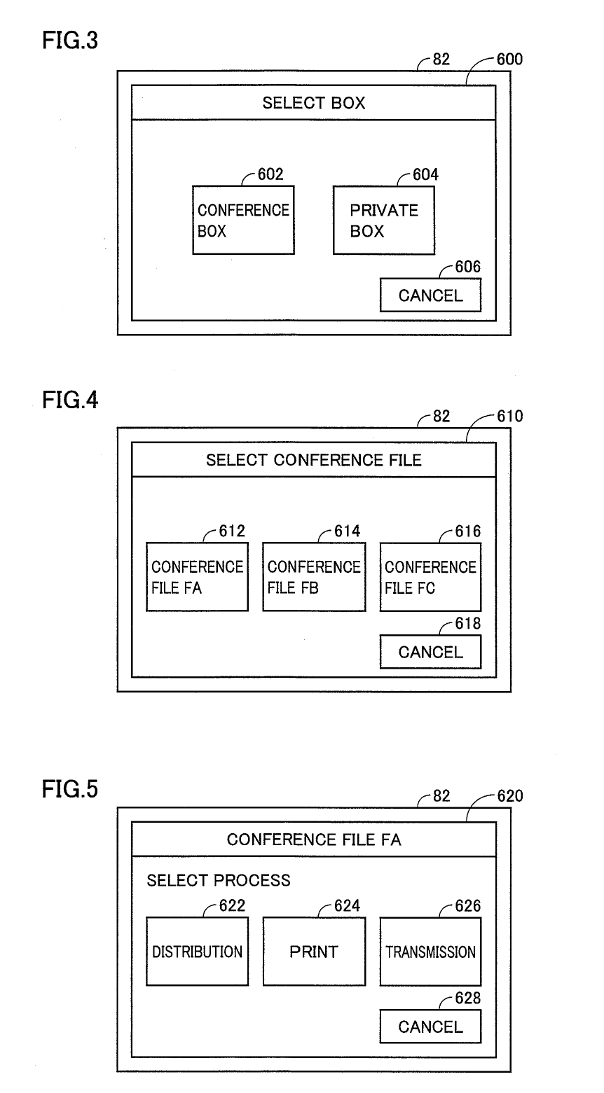

The box selection window when the box button is selected, will be described with reference to FIG. 3.

Referring to FIG. 3, on a box (BOX) selection window 600, a conference box button 602 and a private box button 604 are provided, allowing an access to a conference box (BOX) and a private box (BOX) provided in advance, respectively. When a cancel button 606 is selected, the box selection window is closed and the display returns to the initial image. The conference box and the private box are formed by prescribed memory areas of HDD 26.

Here, by selecting conference box button 602, it is possible to access to conference box data stored in the hard disk (HDD) 26. By selecting private box button 604, it is possible to access to private box data. In the present example, operation device 84 includes a touch panel provided on display 82. Therefore, when the button is pressed by a finger, the button can be selected. Not a finger but a touch pen or the like may be used. The same applies to the following.

A conference file selection window when the conference box button is pressed in the state of FIG. 3 will be described with reference to FIG. 4.

Referring to FIG. 4, on conference file selection window 610, by way of example, conference files FA, FB and FC are displayed as selectable files, in the present embodiment. Specifically, a conference file FA selection button 612, a conference file FB selection button 614, and a conference file FC selection button 616 are provided. When a cancel button 618 is selected, the conference file selection window is closed and the display returns to the initial image.

When the user selects any of conference file FA selection button 612, conference file FB selection button 614 and conference file FC selection button 616 on conference file selection window 610, the next, conference file process selection window is displayed.

The conference file process selection window will be described with reference to FIG. 5.

Referring to FIG. 5, on a conference file process selection window 620, in the present example, selection buttons for selecting a process to be conducted on conference file FA are provided. Specifically, a distribution button 622, a print button 624 and a transmission button 626 are displayed in selectable states. If distribution button 622 is selected, execution of data distribution process on conference file FA is instructed. If print button 624 is selected, execution of printing process on conference file FA is instructed. If transmission button 626 is selected, execution of a transmission process on conference file FA is instructed. When a cancel button 628 is selected, the conference file process selection window is closed and the display returns to the initial image.

In the present embodiment, description will be given assuming that the user selects distribution button 622 to instruct execution of data distribution process of distributing data stored in the box (BOX) (hereinafter also referred to as the box distribution process). By way of example, here, the box distribution process of conference file FA will be described. Further, it is assumed that conference data FA is file data including a plurality of pages. Further, it is assumed that the whiteboard function is being executed.

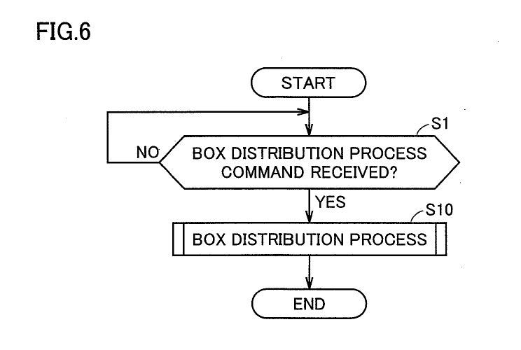

Activation of the box (BOX) distribution process in MFP 10 in accordance with Embodiment 1 of the present invention will be described with reference to FIG. 6.

The process shown in the flowchart of FIG. 6 is realized by CPU 25 of MFP 10 executing a prescribed program stored in ROM 22. The same applies to other process flows executed by CPU 25 of MFP 10.

Referring to FIG. 6, first, CPU 25 determines whether or not an input of a box (BOX) distribution process command has been received (step S1). Specifically, as an example, whether or not distribution button 622 has been pressed on conference file process selection window 610 is determined.

Next, CPU 25 executes the box (BOX) distribution process (step S10).

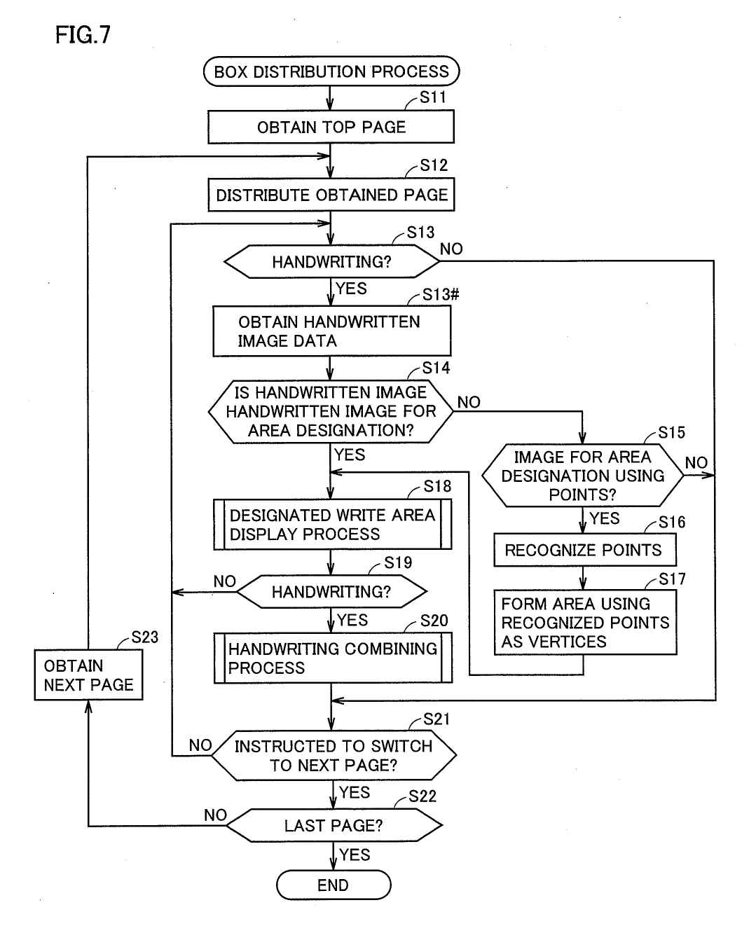

The box distribution process in accordance with Embodiment 1 of the present invention will be described with reference to FIG. 7.

Referring to FIG. 7, at the start, a first page is obtained (step S11). Specifically, CPU 25 reads, from HDD 26, data of the first page of the plurality of pages forming conference file FA, for the selected conference file FA. Then, it stores the read data in image memory 94.

Next, CPU 25 distributes the obtained page to display device 101 (step S12). Specifically, CPU 25 stores the data of first page stored in image memory 94 in image memory 92, as distribution data.

Next, screen display I/F 29 outputs the distribution data stored in image memory 92 to display device 101. Thus, the distribution data output from screen display I/F 29 is input to image input terminal 208 of display device 101, and displayed on display area 102.

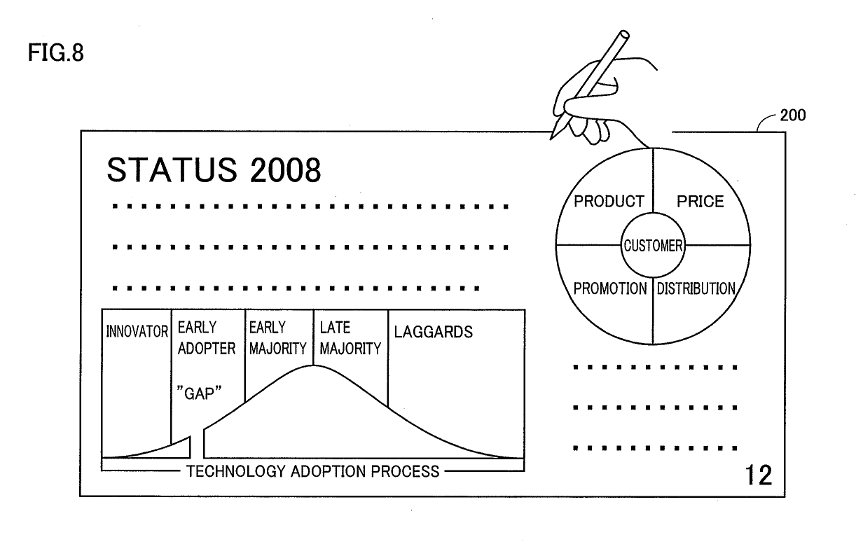

An image 200 displayed on display area 102 of display device 101 in accordance with Embodiment 1 of the present invention will be described with reference to FIG. 8.

FIG. 8 shows a state in which handwriting has not been executed. Specifically, on the display area of display device 101, the distribution data is displayed.

Again referring to FIG. 7, CPU 25 next determines whether there has been handwriting (step S13).

Specifically, whether or not there has been an input of coordinate data from touch panel coordinate position detecting unit 214 of display device 101 to coordinate data input unit 90 in accordance with touching of touch pen 105 is determined.

If it is determined at step S13 that the handwriting has been done, CPU 25 obtains the handwritten image data (step S13#). Specifically, CPU 25 stores the handwritten image data in image memory 96, by the whiteboard function, based on the input coordinate data.

When the whiteboard function is being executed, CPU 25 combines the handwritten image data stored in image memory 96 with the distribution data stored in image memory 94, and outputs the result to image memory 92. The combined image data stored in image memory 92 is output through screen display I/F 29 to display device 101. Thus, a drawing operation is executed in display area 102 of display device 101 in accordance with the track touched by touch pen 105.

Next, CPU 25 determines whether or not the handwritten image is an area designating image by handwriting, based on the obtained handwritten image data (step S14). Specifically, CPU 25 can make this determination by determining whether or not the handwritten image data that has been stored in image memory 96 includes a line image surrounding an image area of a certain size or larger.

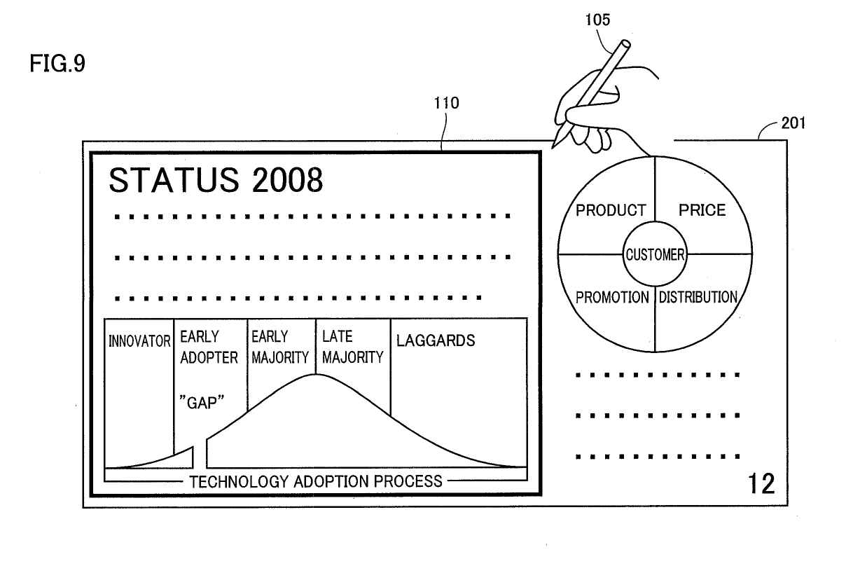

An image 201 displayed on display area 102 of display device 101 in accordance with Embodiment 1 of the present invention will be described with reference to FIG. 9.

Referring to FIG. 9, here, an example is shown in which the handwriting as a hand-written area designation is done.

Specifically, a line image 110 drawn to surround an image area of a certain size or larger, in accordance with a track of touch pen 105, is displayed. Thus, CPU 25 determines that the handwritten image data is a handwritten image for area designation.

Again referring to FIG. 7, if it is determined at step S14 that the handwritten image is a handwritten image for area designation based on the obtained handwritten image data, CPU 25 next executes a designated write area display process (step S18). The designated write area display process will be described later.

If it is determined at step S14 that the handwritten image is not a handwritten image for area designation based on the obtained handwritten image data, CPU 25 next determines whether or not the handwritten image is an image for area designation using points (step S15). Specifically, CPU 25 can make this determination based on whether the handwritten image data that has been stored in image memory 96 includes a plurality of points of a prescribed shape. By way of example, it is possible to use whether four circular points are included or not as an index.

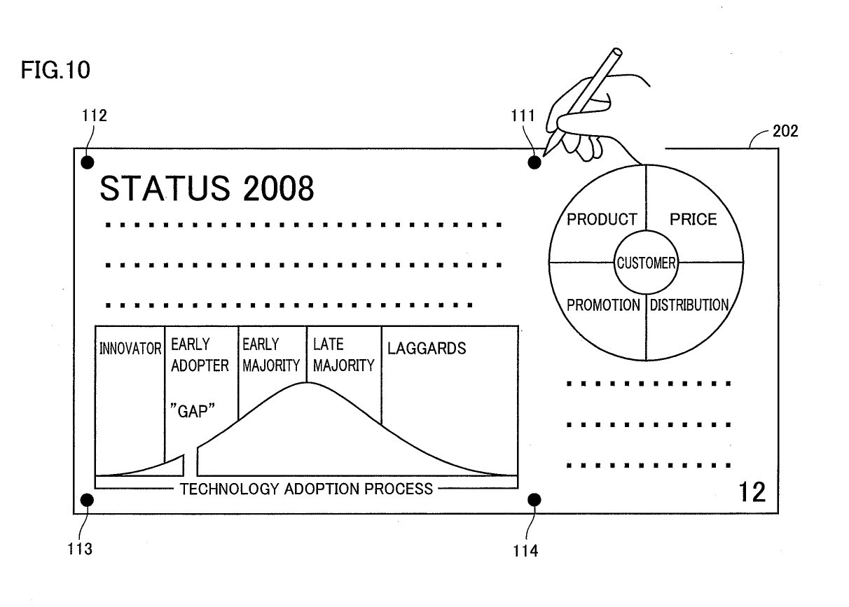

An image 202 displayed on display area 102 of display device 101 in accordance with Embodiment 1 of the present invention will be described with reference to FIG. 10.

Referring to FIG. 10, here, an example is shown in which handwriting as an area designation using points has been executed.

Specifically, points of a prescribed shape, here, four circular points, are drawn to surround an area in accordance with the track of touch pen 105. Specifically, points 111, 112, 113 and 114 are shown surrounding and designating a certain image area. CPU 25 determines that the handwritten image data that has been stored in image memory 96 to be an image for area designation using points. Though circular points are described here, the shape is not limited to a circle and the point may have triangular, rectangular or any other identifiable shape.

Again referring to FIG. 7, if it is determined at step S15 that the handwritten image is an image for area designation using points, CPU 25 executes a point recognition process (step S16). Specifically, CPU 25 extracts coordinate position data of circular points of the handwritten image data stored in image memory 96.

Next, after execution of point recognition process at step S16, CPU 25 forms an area designating image with the recognized points serving as vertices (step S17). Specifically, based on the coordinate position data of recognized circular points, a line image is formed, which is drawn to virtually surround a prescribed image area, using the four points as vertices. By way of example, a line image 110 that has been described with reference to FIG. 9 is virtually formed. Such a process may be executed using RAM 23, for example, used as the work area for CPU 25. It is also possible to form a line image virtually drawn to surround a prescribed image area using the four points as vertices and to store it in image memory 96.

Next, control proceeds to step S18, and a designated write area display process, which will be described later, is executed.

Next, after the designated write area display process of step S18 is complete, CPU 25 determines whether or not there has been handwriting (step S19). Specifically, CPU 25 determines whether or not there has been handwriting to the designated write area, which will be described later.

If it is determined that there has been handwriting, handwriting combining process is executed (step S20). The handwriting combining process will be described later.

If it is determined at step S19 that there has been no handwriting, CPU 25 returns the control to step S13.

Next, after execution of handwriting combining process at step S20, CPU 25 determines whether there is an instruction to switch to a next page (step S21). Specifically, it determines whether or not a switch instruction button provided on operation device 84 on operation panel 80 has been pressed. If the switch instruction button is provided on remote controller 45, pressing of the switch instruction button provided on remote controller 45 may be detected by remote control detecting unit 35, and CPU 25 may determine based on whether or not an input of detection result has been received from remote control detection unit 35.

If it is determined at step S21 that there is an instruction to switch to the next page, the control proceeds to step S22, at which CPU 25 determines whether or not the present page is the last page (step S22).

If it is determined at step S22 that the present page is not the last page, CPU 25 obtains the next page (step S23). Next, the control returns to step S12, and the distribution process for the next page is executed. The process steps described above are repeated, and if the page is determined to be the last page at step S22, the box distribution process ends (END).

If it is determined at step S15 that the input image is not the point image for area designation, the control proceeds to step S21.

CPU 25 determines whether there is an instruction to switch to a next page (step S21). Specifically, it determines whether or not a switch instruction button provided on operation device 84 on operation panel 80 has been pressed.

If it is determined at step S21 that there is an instruction to switch to the next page, the control proceeds to step S22, at which CPU 25 determines whether or not the present page is the last page (step S22). Thereafter, similar process steps are executed and, therefore, detailed description will not be repeated.

If it is determined at step S22 that there is not an instruction to switch to the next page, the control returns to step S13.

Therefore, if there is no handwriting to the distributed page, or if there is handwriting that is not an image for area designation, the designated write area display process of step S18 is not executed and, in accordance with the instruction to switch to the next page, the control proceeds to step S22.

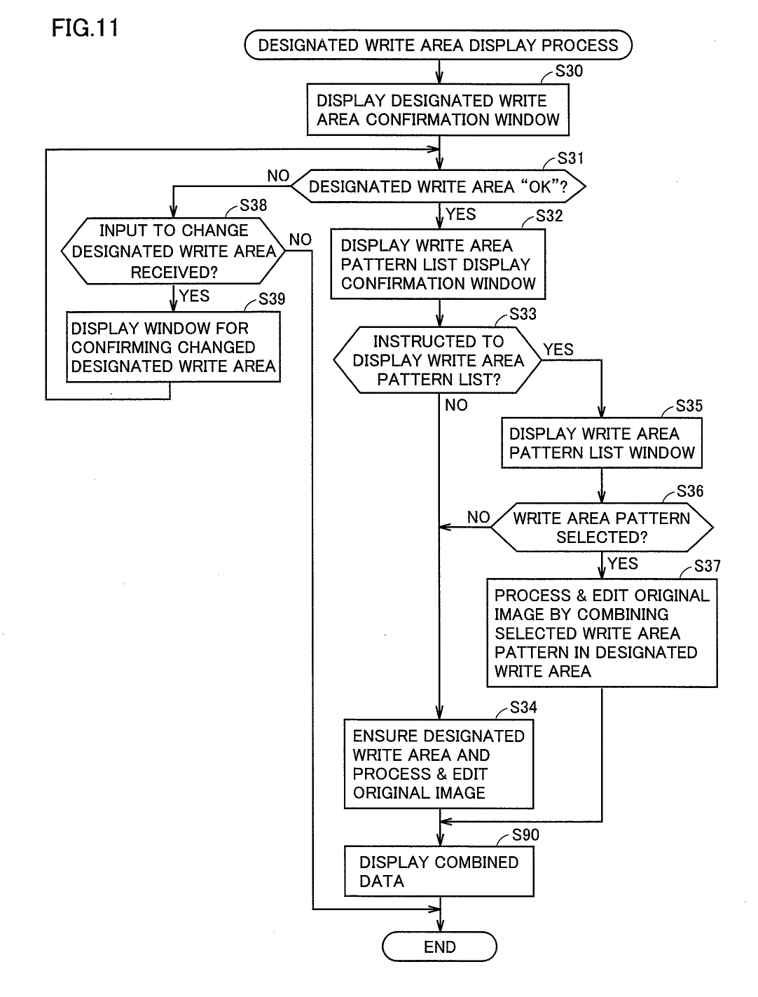

The designated write area display process in accordance with Embodiment 1 of the present invention will be described with reference to FIG. 11.

Referring to FIG. 11, first, CPU 25 displays a confirmation window for confirming the designated write area (step S30).

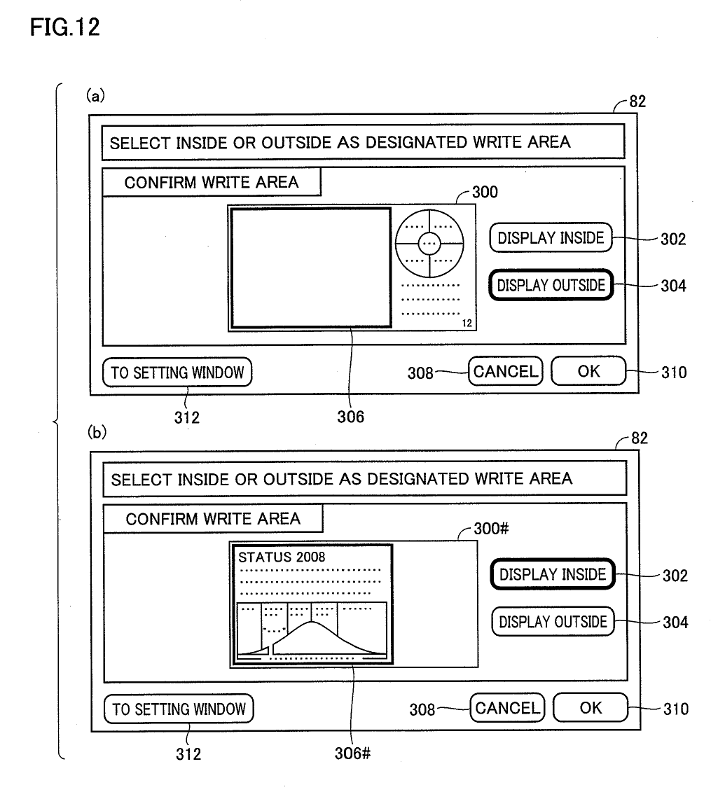

The confirmation window for confirming the designated write area will be described with reference to FIG. 12.

Referring to FIG. 12(a), here, a window for confirming designated write area, asking selection as to whether the designated write area is inside or outside the surrounding line image, is displayed on display 82 of the operation panel.

Here, CPU 25 generates a write area confirmation image 300 based on the area designating image described above and the distribution data stored in image memory 94 as the image for confirming designated write area, which is displayed on display 82 of the operation panel. Specifically, an example is shown in which images of the distribution data inside an area 306 surrounded by line image 110 described with reference to FIG. 9 are not shown while images outside the area are displayed. In this example, the designated write area corresponds to the inside of area 306.

In the present example, “DISPLAY OUTSIDE” button 304 is shown in the selected state.

On the other hand, if “DISPLAY INSIDE” button 302 is selected, an image of FIG. 12(b) is displayed.

Referring to FIG. 12(b), here, CPU 25 generates a write area confirmation image 300# based on the area designating image described above and the distribution data stored in image memory 94 as the image for confirming designated write area, which is displayed on display 82 of the operation panel. Specifically, an example is shown in which images of the distribution data inside an area 306# surrounded by line image 110 described with reference to FIG. 9 is shown while images outside the area are not displayed. In this example, the designated write area corresponds to the outside of area 306#.

In the present example, “DISPLAY INSIDE” button 302 is shown in the selected state. If “DISPLAY OUTSIDE” button 304 is pressed in the state of FIG. 12(b), the image of FIG. 12(a) is displayed.

If “TO SETTING WINDOW” button 312 is pressed here, various settings related to writing can be done. The window for various settings related to writing will be described later.

If “CANCEL” button 308 is pressed here, the process for displaying the designated write area ends, and the process proceeds assuming that no designation was done. Here, at step S19 of FIG. 7, CPU 25 determines that there is no handwriting, the designated write area is not ensured, and the control returns to step S13.

On the other hand, if “OK” button 310 on the designated write area confirmation window is selected, the image displayed in the designated write area confirmation window is displayed on display device 101.

Again referring to FIG. 11, CPU 25 determines whether designated write area “OK” is input or not (step S31). Specifically, whether “OK” button 310 of designated write area confirmation window is selected or not as described above is determined.

If it is determined at step S31 that “OK” is input for the designated write area, CPU 25 displays a window for confirming write area pattern list display (step S32). The window for confirming write area pattern list display will be described later.

If “OK” button is not pressed for the designated write area at step S31, CPU 25 determines whether or not there has been an input for changing the designated write area (step S38). Specifically, it determines whether “DISPLAY INSIDE” button 302 is selected in the state of FIG. 12(a) or “DISPLAY OUTSIDE” button 304 is selected in the state of FIG. 12(b).

If there has been a change input for the designated write area at step S38, CPU 25 displays the changed designated write area confirmation window on display 82 of the operation panel (step S39). Specifically, if “DISPLAY INSIDE” button 302 is selected in the state of FIG. 12(a) as described above, the designated write area confirmation window of FIG. 12(b) is displayed. If “DISPLAY OUTSIDE” button 304 is selected in the state of FIG. 12(b), the designated write area confirmation window of FIG. 12(a) is displayed.

If there is no input for changing the designated write area at step S38, specifically, if “CANCEL” button 308 is pressed, CPU 25 ends the process for displaying the designated write area.

Next, the window for confirming write area pattern list display will be described.

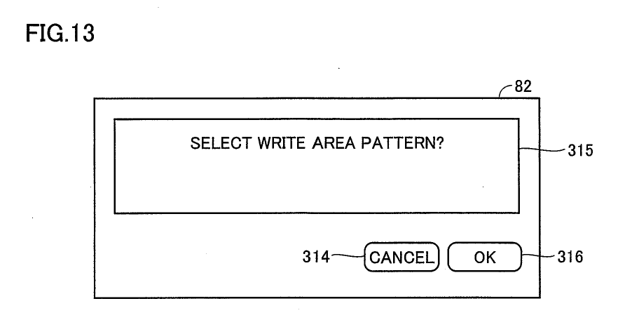

The window for confirming write area pattern list display in accordance with Embodiment 1 of the present invention will be described with reference to FIG. 13.

Referring to FIG. 13, on display 82 of the operation panel, a window 315 is displayed, asking whether the write area pattern stored in HDD 26 in advance is to be selected. If “OK” button 316 is pressed here, a window of write area pattern list is displayed.

If “CANCEL” button 314 is selected, the control proceeds to the next step, assuming that there is no instruction to display the write area pattern list.

Again referring to FIG. 11, after the window for confirming write area pattern list display is displayed (step S32), CPU 25 determines whether or not there is an instruction to display the write area pattern list (step S33).

If there is an instruction to display the write area pattern list at step S33, specifically, if “OK” button 316 is selected in FIG. 13, CPU 25 displays a write area pattern list window (step S35).

If there is not an instruction to display the write area pattern list at step S33, specifically, if “CANCEL” button 314 is selected in FIG. 13, the designated write area is ensured and the process for processing and editing the original image data (distribution data) is executed (step S34).

Then, the combined data is displayed (step S90).

Thus, the process ends (END).

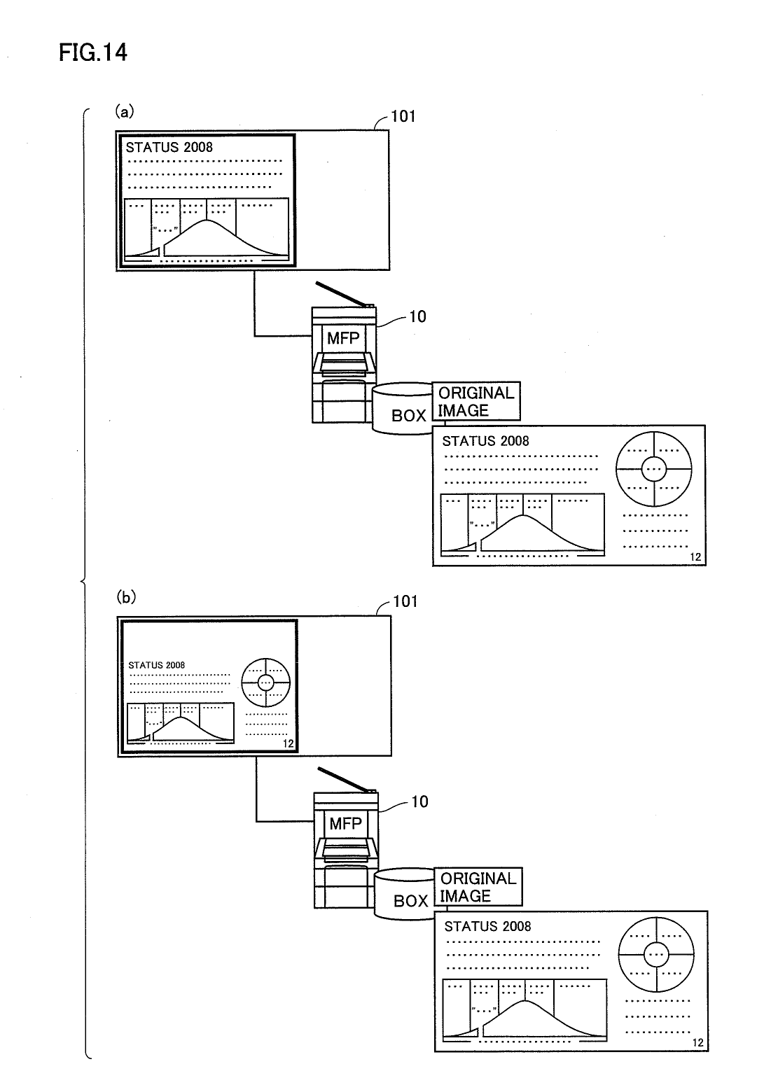

An example in which the combined data obtained by processing and editing the original image while ensuring the designated write area in accordance with Embodiment 1 of the present invention will be described with reference to FIG. 14.

Referring to FIG. 14(a), here an example is shown in which the original data (distribution data) is stored in the BOX of MFP 10, and on display device 101, combined data ensuring the designated write area with respect to the original image data, is displayed.

In the present example, the combined data provided when “OK” button 310 is pressed in the window for confirming designated write area of FIG. 12(b) is shown.

Specifically, as regards the area surrounded by line image 110 of FIG. 9, CPU 25 determines that the handwritten image is the handwritten image for area designation, based on the obtained handwritten image data. Alternatively, as regards the area surrounded by points 111 to 114 of FIG. 10, CPU 25 determines that the handwritten image is the image for area designation by points, based on the obtained handwritten image data.

Then, CPU 25 obtains the distribution data stored in image memory 94 and processes and edits the data such that, based on the determined area designation image, the corresponding area appears in the area designation image. As for the designated write area outside the area designation image, the corresponding data is processed to display nothing, that is, to null data. Such a process can be executed by using RAM 23 used as the work area of CPU 25.

Then, CPU 25 stores the processed and edited combined data in image memory 92.

Thereafter, by screen display I/F 29, the processed and edited combined data stored in image memory 92 is output to display device 101, and displayed on display device 101 as shown in the figure.

Though an example in which null data is stored as the data for displaying nothing has been described, data displayed in a prescribed color may be stored if display device 101 is capable of displaying not a monochrome image but a color image.

Referring to FIG. 14(b), here an example is shown in which the original data (distribution data) is stored in the BOX of MFP 10, and on display device 101, combined data ensuring the designated write area with respect to the original image data, is displayed.

In this example also, the combined data provided when “OK” button 310 is pressed in the window for confirming designated write area of FIG. 12(b) is shown.

Here, different from the combined data shown in FIG. 14(a), combined data is displayed such that the original image data (distribution data) is displayed reduced in size so that the data can be displayed inside the area surrounded by line image 110, and nothing is displayed on other areas.

Specifically, as regards the area surrounded by line image 110 of FIG. 9, CPU 25 determines that the handwritten image is the handwritten image for area designation, based on the obtained handwritten image data. Alternatively, as regards the area surrounded by points 111 to 114 of FIG. 10, CPU 25 determines that the handwritten image is the image for area designation by points, based on the obtained handwritten image data.

Then, CPU 25 obtains the distribution data stored in image memory 94 and processes and edits the data such that, based on the determined area designation image, the distribution data is reduced so that the distribution data as a whole is displayed within the area designation image. As for the designated write area outside the area designation image, the corresponding data is processed to display nothing, that is, for example, to null data.

Such a process can be executed by using RAM 23 used as the work area of CPU 25.

Then, CPU 25 stores the processed and edited combined data in image memory 92.

Thereafter, by screen display I/F 29, the processed and edited combined data stored in image memory 92 is output to display device 101, and displayed on display device 101 as shown in the figure.

By the arrangement described above, the designated write area is ensured on display device 101, and it is possible for the user to execute handwriting to the designated write area.

By the method in accordance with the present embodiment, the designated write area is ensured and, therefore, if the distribution data is displayed on the entire area of display device 101 and handwriting is to be made on display device 101, it is possible to avoid confusion of the written contents caused by overlapping on the displayed image.

Further, by the method in accordance with the present embodiment, the designated write area is ensured and, therefore, the problem that handwriting at an appropriate position is impossible because of space limitation, for example, there is no space for handwriting or only a corner of an area is available as the space for handwriting, can be solved. Thus, user convenience is improved and more smooth progress of a conference becomes possible.

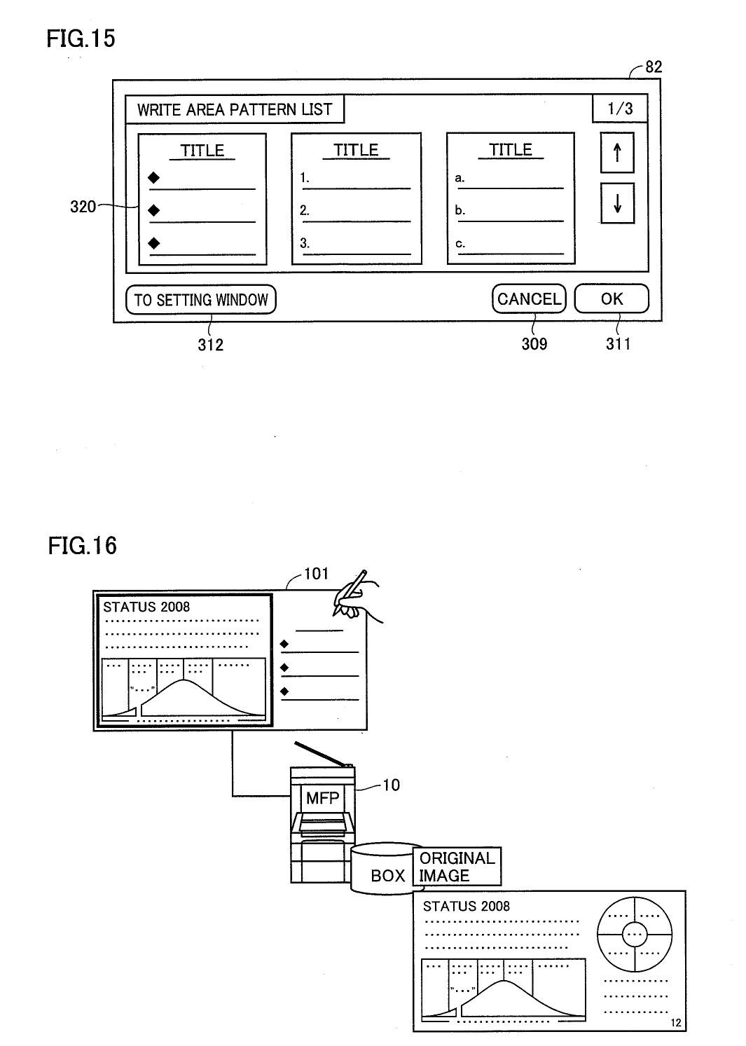

The window of write area pattern list related to step S33 of FIG. 11 in accordance with Embodiment 1 of the present invention will be described with reference to FIG. 15.

Referring to FIG. 15, on display 82 of operation panel 80, a list is displayed, including a plurality of write area patterns 320. Here, it is assumed that the plurality of write area patterns 320 are stored in advance in HDD 26.

It is possible for the user to select one of the plurality of write area patterns 320 on display 82 of operation panel 80, as the handwriting area image data.

Again referring to FIG. 11, after the window of write area pattern list is displayed (step S35), whether a write area pattern has been selected or not is determined (step S36). If a write area pattern is selected at step S36, next, the selected write area pattern is combined in the designated write area, and thus the processing and editing of original data is executed (step S37). Then, the combined data is displayed (step S90).

If the write area pattern is not selected at step S36, the control proceeds to step S34. Process steps after step S34 are the same as those described above and, therefore, detailed description thereof will not be repeated.

An example in which the original image data is processed and edited by combining the selected write area pattern with the designated write area, and the resulting combined data is displayed, in accordance with Embodiment 1 of the present invention will be described with reference to FIG. 16.

Referring to FIG. 16, here, an example is shown in which the original image data (distribution data) is stored in the BOX of MFP 10, and on display device 101, the combined data in which the designated write area is ensured with respect to the original image data is displayed.

In the present example, the combined data obtained when “OK” button 310 is selected on the window for confirming designated write area of FIG. 12(b) and the handwriting pattern 320 on the left end of the window for confirming write area pattern list display of FIG. 15 is selected, is displayed.

Specifically, as regards the area surrounded by line image 110 of FIG. 9, CPU 25 determines that the handwritten image is the handwritten image for area designation, based on the obtained handwritten image data. Alternatively, as regards the area surrounded by points 111 to 114 of FIG. 10, CPU 25 determines that the handwritten image is the image for area designation by points, based on the obtained handwritten image data.

CPU 25 obtains the distribution data stored in image memory 94 and processes and edits the same such that, based on the determined area designating image, the corresponding area is displayed within the area designating image. As for the outside of area designation image, it performs editing process of reducing or enlarging the handwriting area image data as the selected write area pattern, so that it is displayed outside of the area designating image.

Such a process may be executed using RAM 23, for example, used as the work area for CPU 25.

Then, CPU 25 stores the edited and processed combined data in image memory 92.

Thereafter, by screen display I/F 29, the processed and edited combined data stored in image memory 92 is output to display device 101, and displayed on display device 101.

Though an example in which the handwriting pattern 320 on the left end of the window for confirming write area pattern list display of FIG. 15 is selected has been described, it is not limiting, and combination with other handwriting pattern is also possible.

Though an example in which the handwriting pattern is combined and displayed in the designated write area described with reference to FIG. 14(a) has been described, it is also possible to combine and display the handwriting pattern in the designated write area described with reference to FIG. 14(b).

Next, a process of saving the image data obtained by executing the handwriting to the designated write area in accordance with Embodiment 1 of the present invention will be described.

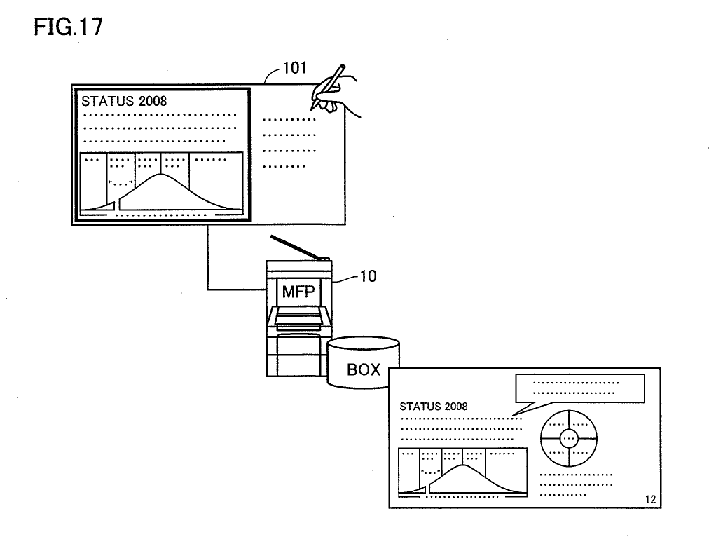

FIG. 17 shows a concept when the handwritten image data obtained by executing handwriting to the designated write area is combined with the original image data (distribution data) and stored in the BOX of MFP 10 in accordance with Embodiment 1 of the present invention.

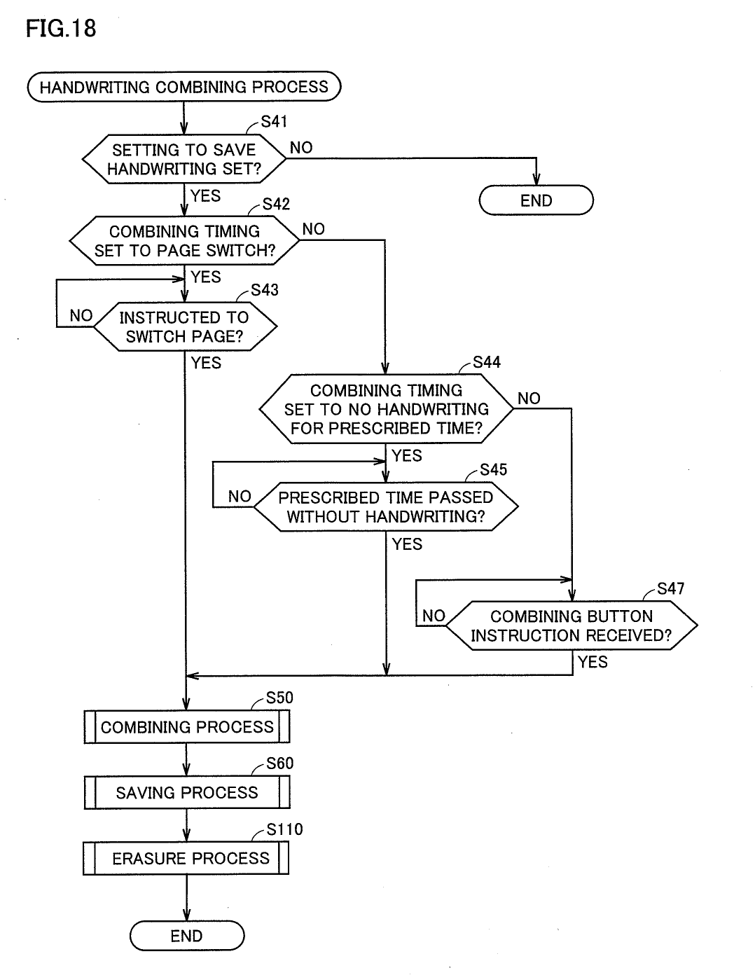

The process for combining the handwriting in accordance with Embodiment 1 of the present invention will be described with reference to FIG. 18.

Referring to FIG. 18, first, CPU 25 determines whether there is any setting for saving the handwriting (step S41).

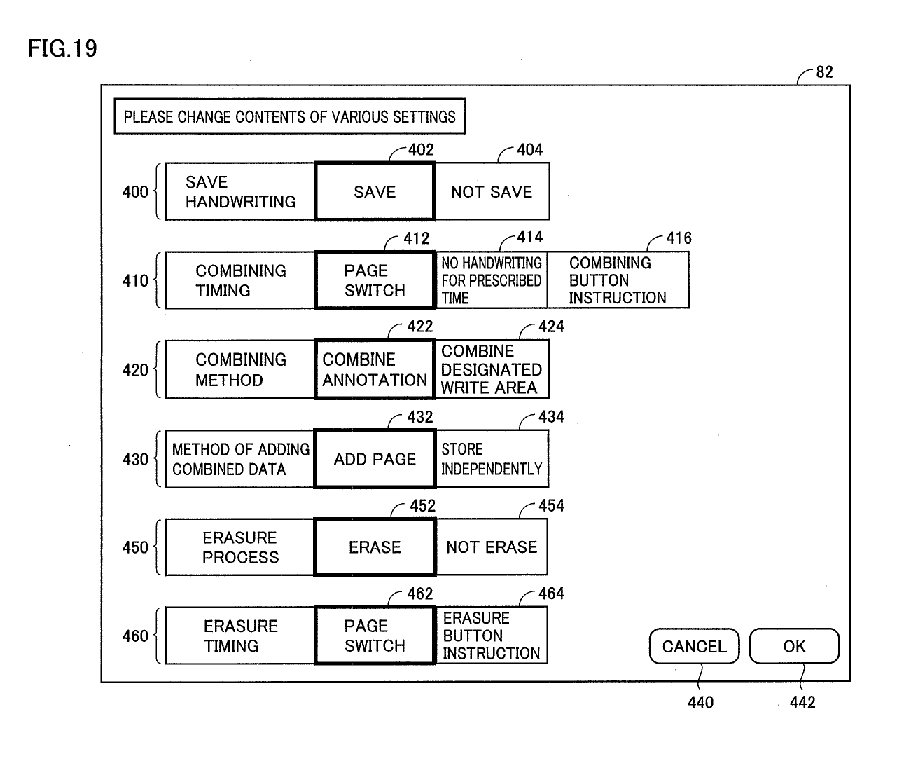

FIG. 19 shows a window for various settings, in accordance with Embodiment 1 of the present invention.

Specifically, when “TO SETTING WINDOW” button 312 is pressed on the window for confirming designated write area shown in FIG. 12, the display on display 82 of the operation panel is switched to the window for various settings, executing various setting processes related to writing. It is also possible to provide “TO SETTING WINDOW” button 312 to enable transition to the window for various settings on a window other than the window for confirming designated write area shown in FIG. 12, on display 82 of the operation panel.

Referring to FIG. 19, by way of example, on display 82 of the operation panel, there is a display of “PLEASE CHANGE CONTENTS OF VARIOUS SETTINGS” and, an item 400 for setting handwriting saving, an item 410 for setting combining timing, an item 420 for setting combining method, an item 430 for setting a method of adding combined data, an item 450 for setting erasure process, and an item 460 for setting erasure timing are provided.

Here, if “SAVE” button 402 for item 400 for setting handwriting saving is pressed, the handwriting saving is set. If “NOT SAVE” button 404 is pressed, setting of handwriting saving is cancelled.

If “PAGE SWITCH” button 412 of item 410 for setting combining timing is pressed, the combining timing is set to the time when the page is switched, as will be described later. Further, “NO WRITING FOR PRESCRIBED TIME” button 414 is selected, the combining timing is set to when writing is not done for a prescribed timing. If “COMBINATION BUTTON INSTRUCTION” button 416 is selected, the combining timing is set to when the combination button is pressed to instruct combination.

If “COMBINE ANNOTATION” button 422 of item 420 for setting combining method is pressed, the combining method is set to a process in which the original image data is reduced in size and the handwritten image data is combined as annotation. If “COMBINE DESIGNATED WRITE AREA” button 424 is selected, the combining method is set such that the designated write area is directly combined with the original image data.

If “ADD PAGE” button 432 of item 430 for setting a method of adding combined data is selected, the method of adding the combined data is set to add the data combined to the original image as an additional page. If “STORE INDEPENDENTLY” button 434 is selected, the method of adding the combined data is set such that the combined data is stored independently in HDD 26.

If “ERASE” button 452 of item 450 for setting erasure process is selected, the erasure process is set. If “NOT ERASE” button 454 is selected, the erasure process is not set.

If “PAGE SWITCH” button 462 of item 460 for setting erasure timing is selected, the erasure timing is set to when the page is switched, as will be described later. Further, if “ERASURE” button 464 is selected, the erasure timing is set to when the ERASURE button is pressed to instruct erasure.

Again referring to FIG. 18, if it is determined at step S41 that the setting for handwriting saving is not set, CPU 25 ends the process (END).

Specifically, on the window for various settings shown in FIG. 19, if “NOT SAVE” button 404 of item 400 for setting handwriting saving is selected and the setting of handwriting saving is not set, the process ends.

At step S41, if it is determined that setting for handwriting saving is set, specifically, if SAVE” button 402 of item 400 for setting handwriting saving is selected and the setting of handwriting saving is set on the window for various settings shown in FIG. 19, CPU 25 next determines whether or not the combining timing is set to the page switch (step S42).

Specifically, on the window for various settings shown in FIG. 19, whether or not “PAGE SWITCH” button 412 of item 410 for setting combining timing is selected and the combining timing is set to the page switch is determined.

If it is determined at step S42 that the combining timing is set to the page switch, CPU 25 proceeds to step S43, at which whether there has been an input of page switch instruction is determined (step S43).

At step S43, if the page switch instruction has been input, CPU 25 executes the combining process (step S50). The combining process will be described later.

If it is determined that the combining timing is not set to the page switch at step S42, CPU 25 determines whether or not the combining timing is set to the timing when there is no writing for a prescribed time (step S44).

Specifically, on the window for various settings shown in FIG. 19, whether or not “NO WRITING FOR PRESCRIBED TIME” button 414 of item 410 for setting combining timing is selected, and the combining timing is set to when there is no writing for a prescribed time period, is determined.

If it is determined at step S44 that the combining timing is set to when there is no writing for a prescribed time, CPU 25 proceeds to step S45, at which whether or not a prescribe time has passed without any writing is determined (step S45). Specifically, it is possible to determine whether or not, after handwriting by a touch pen to the designated write area, a prescribed time has passed without any additional handwriting by a touch pen.

If it is determined at step S45 that a prescribed time has passed without handwriting, CPU 25 executes the combining process (step S50).

If it is determined at step S44 that the combining timing is not set to when there is no writing for a prescribed time, CPU 25 determines whether or not there is an instruction of combining button (step S47). If the combining timing is not set to a page switch, nor to no handwriting for a prescribed time, it is determined the combining timing is set to when there is an instruction of the combining button.

If it is determined at step S47 that there is an instruction of the combining button, CPU 25 executes the combining process (step S50).

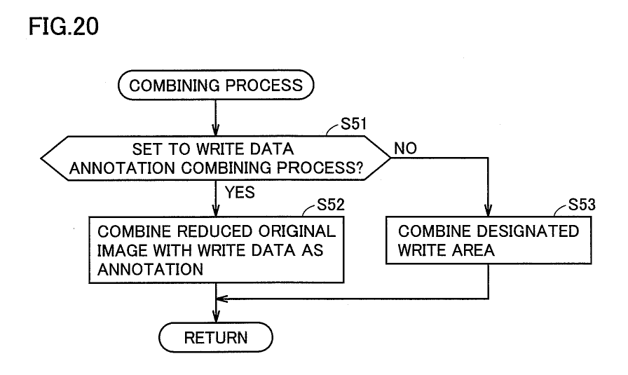

The combining process in accordance with Embodiment 1 of the present invention will be described with reference to FIG. 20.

Referring to FIG. 20, first, CPU 25 determines whether or not there is a setting for the write-data annotation combining process (step S51).

Specifically, whether or not “COMBINE ANNOTATION” button 422 of item 420 for setting combining method is selected and the combining method is set to the process in which the original image data is reduced in size and the handwritten image data that has been input is combined as annotation, is determined.

If it is determined at step S51 that there is a setting for the write-data annotation combining process, CPU 25 executes the process for reducing the original image data in size and combining the handwritten image data as the annotation (step S52).

Then, the process ends (RETURN). Specifically, returning to FIG. 18, the saving process (step S60) is performed. The saving process will be described later.

If it is determined at step S51 that there is not a setting for the write-data annotation combining process, CPU 25 executes the process for combining the designated write area (step S53). The reason for this is that, if there is not a setting for the write-data annotation combining process as the combining process, it can be determined that the process for directly combining the designated write area to the original image data is set as the combining method.

Then, the process ends (RETURN). Specifically, returning to FIG. 18, the saving process (step S60) is performed.

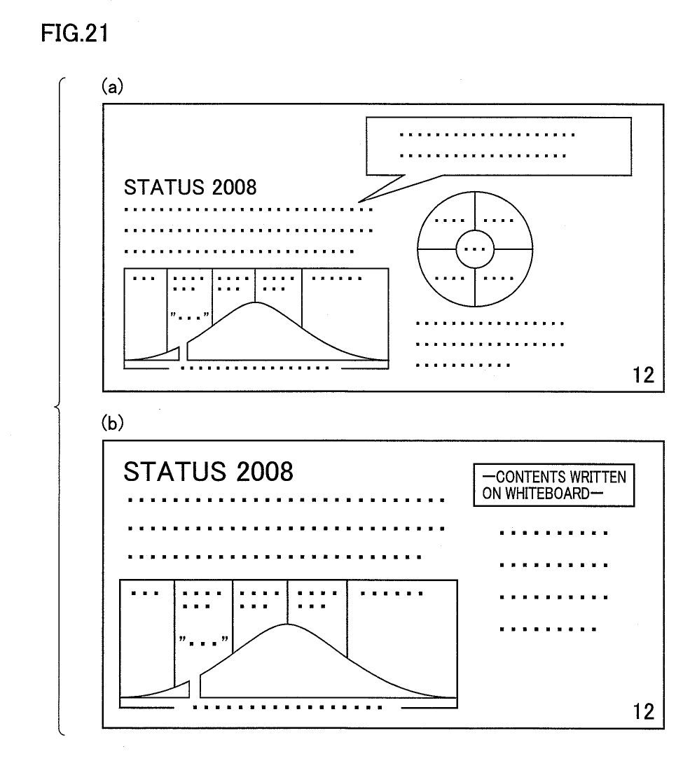

The process of combining the handwritten image data with the original image data in accordance with Embodiment 1 of the present invention will be described with reference to FIG. 21.

FIG. 21(a) shows an example in which the original image data is reduced in size and the written data is combined as an annotation comment.

Specifically, the combining process is executed such that the original image data (distribution data) is reduced to be displayed within the area surrounded by the line image 110 shown in FIG. 9, the handwritten image data that has been written and input outside this area, that is in the designated write area, is processed and edited, and the thus processed data is put as an annotation comment, in the space resulting from the reduction in size of the original image data.

Specifically, as shown in FIG. 14(b), it is assumed that the designated write area is ensured and displayed on display device 101.

When the user executes handwriting to the designated write area, CPU 25 stores the image data handwritten to the designated write area ensured on display device 101, in image memory 96.

For the combining process, CPU 25 obtains the distribution data stored in image memory 94, processes and edits the distribution data to reduce the size of distribution data so that it can be displayed entirely in the area designation image based on the determined area designation image, as for the handwritten image data written in the designated write area, it processes and edits the handwritten image data such that the handwritten image data is inserted as an annotation comment in the space resulting from the reduction of original image data, and CPU 25 combines the results. Such a process may be executed using RAM 23, for example, used as the work area for CPU 25.

FIG. 21(b) shows an example in which the designated write area is directly combined with the original image data.

Specifically, the combining process is executed such that the portion of the original image data (distribution data) corresponding to the area surrounded by the line image 110 of FIG. 9 is displayed, and the handwritten image data that has been written and input in the designated write area, that is, the area outside the surrounded area, is directly displayed.

Specifically, as shown in FIG. 14(a) described above, it is assumed that the designated write area is ensured and displayed on display device 101.

When the user executes handwriting to the designated write area, CPU 25 stores the image data handwritten to the designated write area ensured on display device 101, in image memory 96.

For the combining process, CPU 25 obtains the distribution data stored in image memory 94, processes and edits the distribution data so that the corresponding area is displayed in the area designation image based on the determined area designation image, and combines the result with the handwritten image data that has been written to the designated write area outside the area designation image. Such a process may be executed using RAM 23, for example, used as the work area for CPU 25.

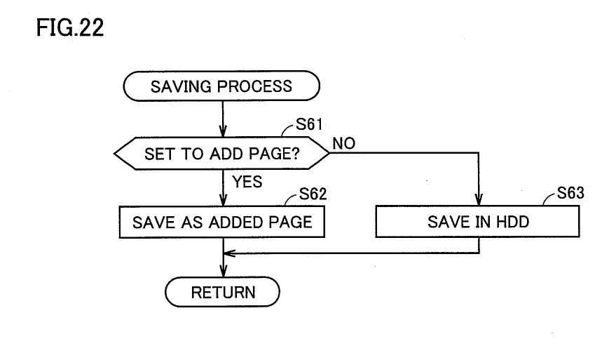

The saving process in accordance with Embodiment 1 of the present invention will be described with reference to FIG. 22.

Referring to FIG. 22, first, CPU 25 determines whether or not there is a page addition setting (step S61). Specifically, whether or not “ADD PAGE” button 432 of item 430 for setting a method of adding combined data is selected and the page addition is set is determined.

If it is determined that page addition is set at step S61, CPU 25 executes a page addition saving process (step S62).

Specifically, CPU 25 performs a process in which the combined data obtained by processing, editing and combining the handwritten image data is added to the distribution data stored in HDD 26, in the present example, the file data of conference file FA, and the result is saved.

If it is determined at step S61 that page addition is not set, CPU 25 executes an HDD saving process (step S63). This is possible because if item 430 for setting a method of adding combined data is not the setting for page addition, it can be determined that the method of adding combined data corresponds to selection of “SAVE INDEPENDENTLY” button 434 and the combined data is set to be stored independently in HDD 26.

Specifically, CPU 25 stores the combined data, obtained by combining the processed and edited handwritten image data, independent from the distribution data, in HDD 26.

Then, the process ends (RETURN). Specifically, returning to FIG. 18, the erasure process is executed (S110).

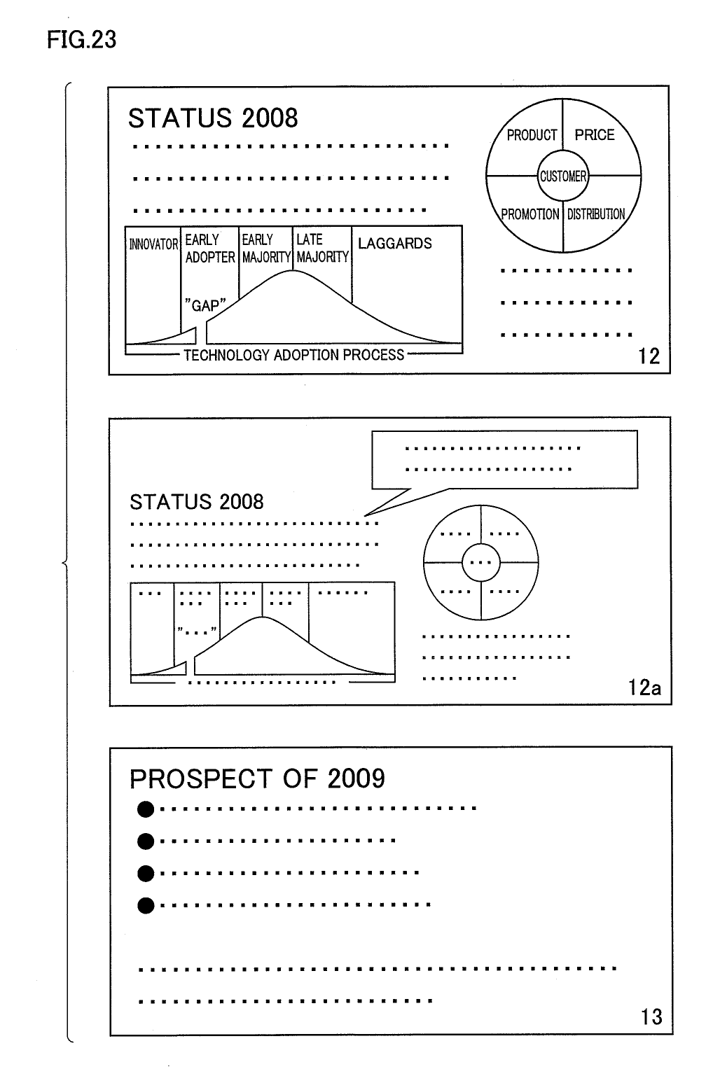

The page addition saving process in accordance with Embodiment 1 of the present invention will be described with reference to FIG. 23.

Referring to FIG. 23, here, an example is shown in which a page 12a is added between pages 12 and 13 that are the distribution data. In the present example, the combined data combined as described with reference to FIG. 21(a) is added.

By this method, it is possible to add the combined data in which the handwritten data input to the designated write area is combined to the original, and to confirm it in the distribution process.

By storing the combined data independently in HDD 26, is it also possible to access the stored combined data for later review.

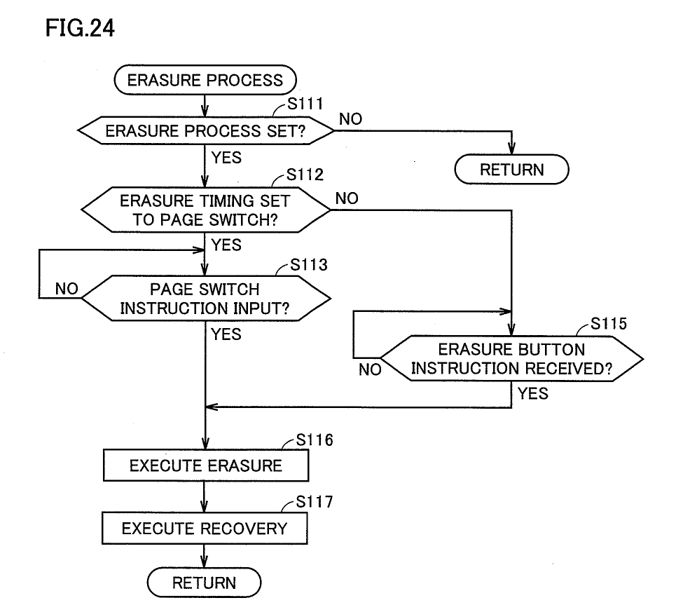

The erasure process in accordance with Embodiment 1 of the present invention will be described with reference to FIG. 24.

Referring to FIG. 24, first, CPU 25 determines whether or not there is an erasure process setting (step S111).

If it is determined at step S111 that the erasure process is not set, CPU 25 ends the process (END).

Specifically, if “NOT ERASE” button 454 of item 450 for setting erasure process is selected and the erasure process is not set on the window for various settings shown in FIG. 19, the process ends.

If it is determined at step S111 that the erasure process is set, that is, if “ERASE” button 452 of item 450 for setting erasure process is selected and the erasure process is set on the window for various settings shown in FIG. 19, CPU 25 next determines whether or not the erasure timing is set at the page switch (step S112).

Specifically, whether or not “PAGE SWITCH” button 462 of item 460 for setting erasure timing is selected on the window for various settings shown in FIG. 19 and the erasure timing is set to the page switch is determined.

If it is determined at step S112 that the erasure timing is set to the page switch, the control proceeds to step S113, at which CPU 25 determines whether or not the page switch instruction has been input (step S113). If it is determined at step S113 that the page switch instruction has been input, CPU 25 executes the erasure process (step S116).

If it is determined at step S112 that the erasure timing is not set to the page switch, CPU 25 determines whether or not there is an instruction of erasure button (step S115). The reason for this is that if the erasure timing is not set to the page switch, it can be determined that the erasure timing is set to the instruction of an erasure button.

If it is determined at step S115 that there is an erasure button instruction, CPU 25 executes the erasure process (step S116). Specifically, in the erasure process, CPU 25 erases the handwritten image data stored in image memory 96.

Then, CPU 25 executes a recovery process (step S117). Specifically, in the recovery process, CPU 25 stores the distribution data that has been stored in image memory 94 to image memory 92. Thus, by way of example, the image 200 on which the handwriting is not executed, described with reference to FIG. 8, comes to be displayed on display device 101.

Then, the process ends (RETURN).

By this step, the erasure process ends, the handwriting combining process of FIG. 18 ends, and the control proceeds to step S21 of FIG. 7.

Therefore, by the recovery before execution of the handwriting, the original state is resumed, so that convenience for the user is improved and the conference can smoothly be proceeded.

### Embodiment 2

In Embodiment 1, a data distribution system has been described, in which MFP 10 is connected to display device 101 and the distribution data stored in HDD 26 of MFP 10 is displayed on display device 101. In Embodiment 2, a data distribution system in which the distribution data is projected on a whiteboard using a projector will be described.

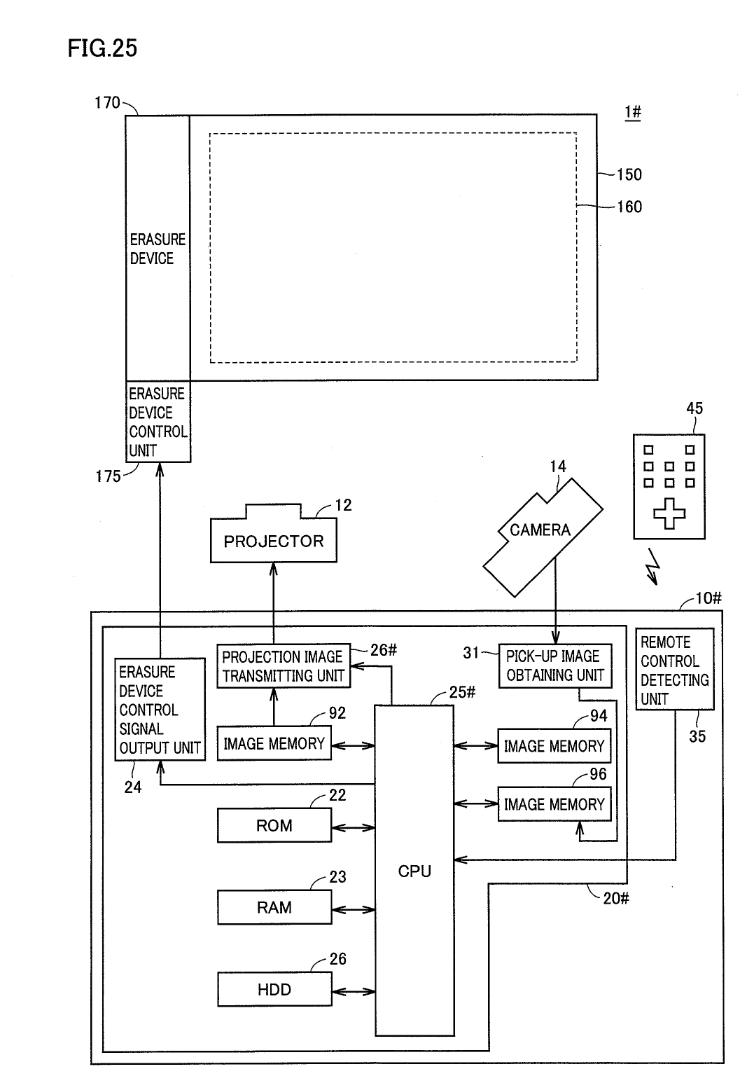

The conference system 1# (data distribution system) in accordance with Embodiment 2 will be described with reference to FIG. 25.

Referring to FIG. 25, conference system 1# in accordance with Embodiment 2 of the present invention includes an MFP 10#, a whiteboard 150 serving as a screen on which images are projected (hereinafter also referred to as a “screen”), a projector 12 as a projector projecting the distribution data on whiteboard 15 as the screen, and a camera 14 as an image obtaining device obtaining the image displayed on the whiteboard as the screen.

By way of example, whiteboard 150 allows handwriting using a marker pen. Further, in relation to whiteboard 150 as the screen, an erasure device 170 for erasing a handwritten image by pressure contact, and an erasure device control unit 175 controlling erasure device 170 are provided. Further, a remote controller 45 is provided.

MFP 10# in accordance with Embodiment 2 of the present invention includes a main circuit 20# and a remote control detecting unit 35. Though not shown, automatic document feeder 40, scanner 50, printer 60, paper feed unit 70, operation panel 80, facsimile 27 and the like provided on MFP 10 described with reference FIG. 2 are also provided. These components are similar to those shown in FIG. 2 and, therefore, description thereof will not be repeated.

Different from main circuit 20, main circuit 20# includes a CPU 25# in place of CPU 25, and additionally includes a projection image transmitting unit 26#, a picked-up image obtaining unit 31, and an erasure device control signal output unit 24. Except for these points, components similar to those described with reference to FIG. 2 are provided, though not shown.

Projection image transmitting unit 26# outputs data stored in image memory 92 to projector 12.

Projector 12 projects the distribution data and the like stored in image memory 92 and output from projection image transmitting unit 26# to whiteboard 150 as the screen.

It is assumed that an area 160 surrounded by a dotted line on whiteboard 150 represents an outer frame of the data projected from projector 12.

Picked-up image obtaining unit 31 saves the picked-up image data as the obtained picked-up image in image memory 96.

Remote control detection unit 35 detects an input of remote control signal input from remote controller 45, and outputs a detection signal to CPU 25#.

Erasure device control signal output unit 24 outputs a control signal for driving the erasure device provided on whiteboard 150 as the screen.

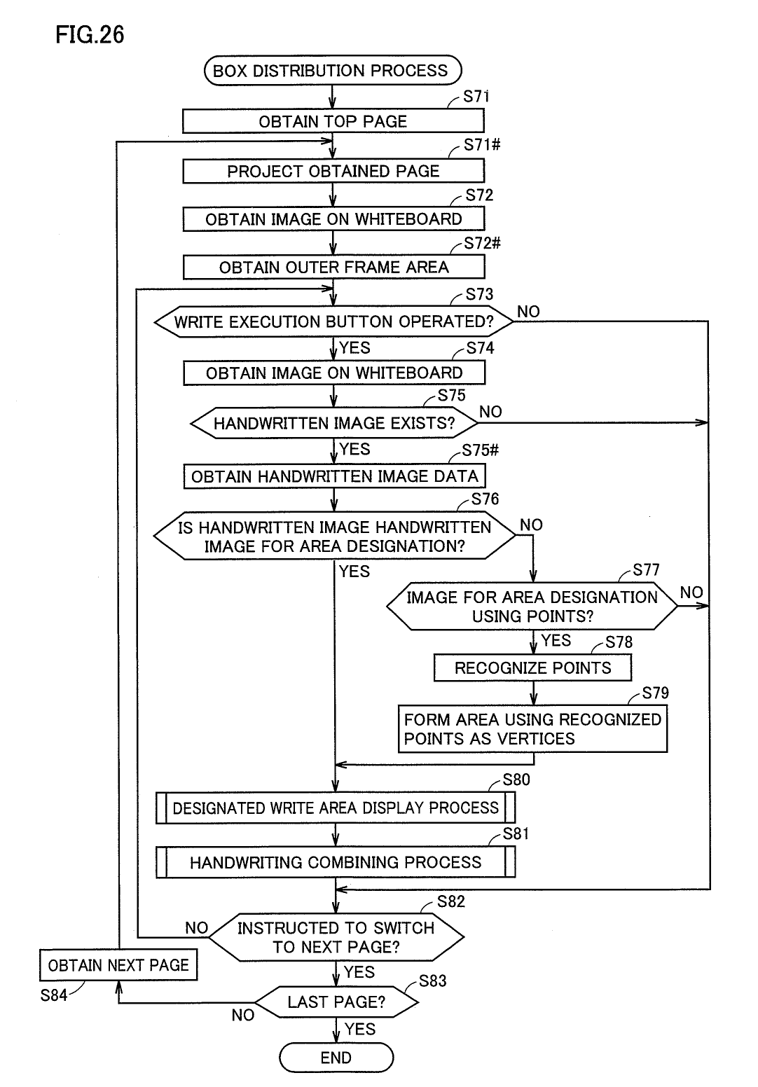

A box distribution process in accordance with Embodiment 2 will be described with reference to FIG. 26.

The process shown in such a flow is realized by CPU 25# of MFP 10# executing a prescribed program stored in ROM 22. The same applies to the process flows executed by CPU 25# of MFP 10#.

Referring to FIG. 26, at the start, a first page is obtained (step S71). Specifically, for the selected conference file FA, CPU 25# reads data of the first page of a plurality of pages forming conference file FA, from HDD 26. Then, it stores the read data in image memory 94.

Next, the obtained page is projected (step S71#). Specifically, CPU 25# stores the data that has been stored in image memory 94 in image memory 92. Projection image transmitting unit 26# outputs the distribution data (projection data) stored in image memory 92 to projector 12. As a result, the projection data is projected from projector 12 to whiteboard 150 as the screen, and the projected image is displayed on whiteboard 150.

The projected image is the same as that described with reference to FIG. 8 and, therefore, detailed description thereof will not be repeated.

Next, CPU 25# obtains the image projected on the whiteboard (step S72). Specifically, the projected image on whiteboard 150 is picked up by camera 14, and the picked-up image data as the picked-up image is output to picked-up image obtaining unit 31. Then, picked-up image obtaining unit 31 stores the picked-up image data in image memory 96.

Next, from the picked-up image data stored in image memory 96, CPU 25# extracts the distribution data display area on the whiteboard, that is, the outer frame area 160 of the data projected from projector 12 (step S72#).

Specifically, outer frame area 160 can be extracted based on a comparison with the distribution data stored in image memory 94. Alternatively, outer frame area 160 may be extracted based on contrast difference between the background color (for example, white) of the screen of whiteboard 150 and the displayed distribution data.

By this process, it is possible to determine the projected data area projected from projector 12, in the picked-up image data next input to image memory 96.

Thereafter, CPU 25# determines whether the write execution button has been operated (step S73).

In the present example, it is assumed that the user executes handwriting to whiteboard 150 before the write execution button operation instruction. Specifically, the handwriting as the handwritten area designation, or the handwriting as the area designation using points, described with reference to FIG. 9 or 10 above, is executed.

Though not shown, it is assumed that on operation device 84 on the operation panel, a write execution button is provided while the distribution data distributing process is being executed. Alternatively, it is assumed that the write execution button is provided on remote controller 45 or the like, and CPU 25# determines whether or not the write execution button has been operated.

Next, if the write execution button has been operated, CPU 25# obtains the image on the whiteboard (step S74). Specifically, the image displayed on the whiteboard is picked-up by camera 14, and the picked-up image data is output to picked-up image obtaining unit 31. Then, picked-up image obtaining unit 31 stores the picked-up image data in image memory 96.

Next, CPU 25# determines whether there is a handwritten image (step S75).

For the picked-up image data stored in image memory 96, CPU 25# compares the image data stored in the extracted outer frame area 160 with the distribution data stored in image memory 94, and if it is determined that there is a difference therebetween, it is determined that there is a handwritten image.

Specifically, by replacing the image data included in the extracted outer frame area 160 with the coordinate position data corresponding to image memory 94, based on the relative positional relation information to extracted outer frame area 160, it is possible to determine at which position of the distribution data the handwritten image has been input.

If it is determined at step S75 that there has been a handwritten image, CPU 25# next obtains the handwritten image data (step S75#). Specifically, CPU 25# obtains the handwritten image data based on the difference between the image data included in extracted outer frame area 160, of the picked-up image data stored in image memory 96, and the distribution data stored in image memory 94. More specifically, relative positional relation data of extracted outer frame area 160 to the handwritten image data is obtained, and based on the information, CPU 25# determines at which position of the distribution data stored in image memory 94 the handwritten image has been input, and obtains the handwritten image data.

Next, based on the obtained handwritten image data, CPU 25# determines whether the handwritten image is handwritten image for area designation or not (step S76). Specifically, CPU 25# determines, for the handwritten image, whether or not a line image surrounding an image area of a certain size or larger is included or not, in the similar manner as described above.

More specifically, based on the relative positional relation information to the extracted outer frame area 160, by replacing the obtained handwritten image data with the coordinate position data corresponding to image memory 94, CPU 25# can determine whether or not the line image surrounding an image area of a certain size or larger is included.

At step S76, if it is determined that the handwritten image is the handwritten area designation image, based on the obtained handwritten image data, CPU 25# next executes a designated write area display process (step S80). The designated write area display process will be described later.

If it is determined at step S76 that the handwritten image is not the handwritten area designation image based on the obtained handwritten image data, CPU 25# determines whether the handwritten image is an area designation image using points (step S77). Specifically, for the same handwritten image as describe above, CPU 25# determines whether or not a plurality of points of a prescribed shape is included. For example, whether or not four circular points are included may be used as an index.

If it is determined at step S77 that the handwritten image is the area designation image using points, CPU 25# next executes the point recognition process (step S78). Specifically, as described in the foregoing, CPU 25# extracts coordinate position data of circular points displayed in outer frame area 160, based on the obtained handwritten image data. The coordinate position data may be converted to the coordinate position data corresponding to image memory 94, based on the relative positional relation information to the extracted outer frame area 160.

After the execution of point recognition process at step S78, CPU 25# forms an area designation image using the recognized points as vertices (step S79). Specifically, using the recognized coordinate position data of circular points, a line image is formed, which is drawn to virtually surround a prescribed image area, with the four points used as vertices.

Next, the control proceeds to step S80, at which the designated write area display process, which will be described later, is executed.

Next, CPU 25# executes handwriting combining process (step S81).

Next, CPU 25# determines whether or not there is a switch instruction to the next page (step S82). Specifically, whether or not the switch instruction button on operation device 84 of operation panel has been pressed or not is determined.

If it is determined at step S82 that there is a switch instruction to the next page, the control proceeds to step S83, at which CPU 25# determines whether the present page is the last page or not (step S83).

If it is determined at step S83 that the present page is not the last page, CPU 25# obtains the next page (step S84). Next, the control returns to step S71#, at which the process for projecting the thus obtained next page is executed. Then, the process steps described above are repeated and if the present page attains to the last page at step S83, CPU 25# ends the box distribution process (END).

If it is determined at step S77 that the image is not the area designation image using points, the control proceeds to step S82.

Next, CPU 25# determines if there is a switch instruction to the next page (step S82). Thereafter, the process steps are the same and, therefore, detailed description thereof will not be repeated.

Therefore, for the projected page, if there is not a write execution button operation instruction, if there is not a handwritten image, or if handwriting is executed that is not the area designation image, the designated write area display process of step S80 is not executed, and in accordance with the instruction to switch to the next page, the control proceeds to step S83.

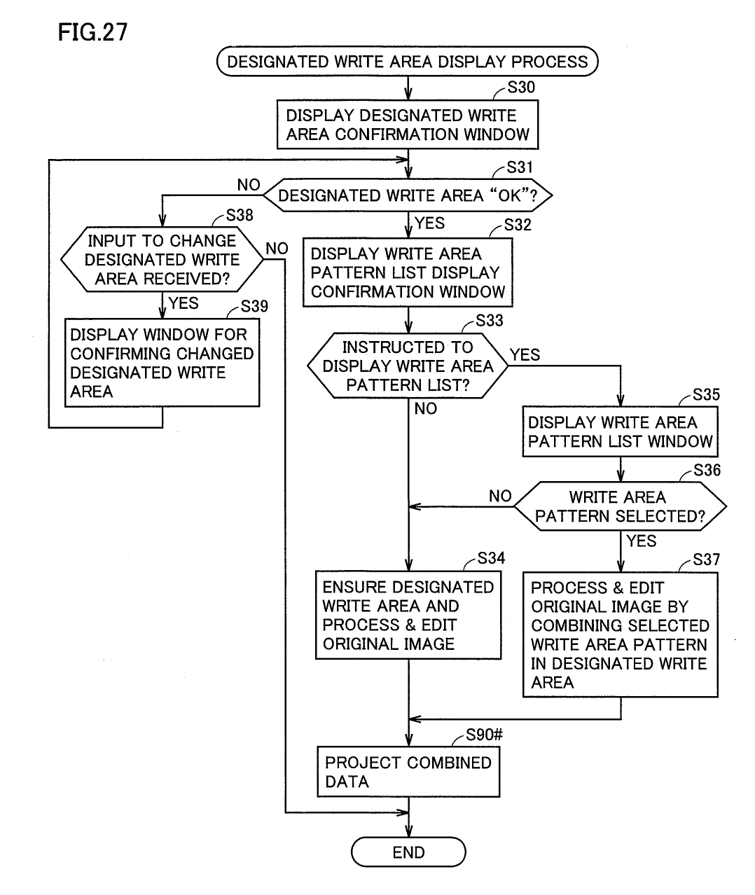

The designated write area display process in accordance with Embodiment 2 of the present invention will be described with reference to FIG. 27.

As described above, by replacing the obtained handwritten image data with the coordinate position data corresponding to image memory 94 based on the relative positional relation information to extracted outer frame area 160, CPU 25# can determine at which position of the distribution data the handwritten image has been input. Therefore, similar process as described with reference to Embodiment 1 can be executed.

Referring to FIG. 27, the process is similar to the designated write area display process described with reference to FIG. 11, except for the process of step S90# at which the combined data with the designated write area ensured, is projected on whiteboard 150 using projector 12. Except for this point, the process is substantially the same as that described with reference to FIG. 11 and, therefore, detailed description thereof will not be repeated.

As to the process of processing and editing the original image data (distribution data) while ensuring the designated write area at step S34, CPU 25# obtains the distribution data stored in image memory 94 and processes and edits the data such that, based on the determined area designation image, the corresponding area appears in the area designation image. As for the designated write area outside the area designation image, the corresponding data is to display nothing, that is, null data. Such a process can be executed by using RAM 23 used as the work area of CPU 25#. Though an example in which null data is stored as the data for displaying nothing is stored has been described, data displaying in a prescribed color may be stored if display device 101 is capable of displaying not a monochrome image but a color image.

Then, CPU 25# stores the processed and edited combined data in image memory 92.

Further, as to the process of processing and editing the original image data by combining the selected write area pattern in the designated write area at step S37, CPU 25# obtains the distribution data stored in image memory 94 and processes and edits the data such that, based on the determined area designation image, the corresponding area appears in the area designation image. As for the outside of the area designation image, a process for reducing or enlarging is executed such that the handwriting area image data as the selected write area pattern is displayed. Such a process can be executed by using RAM 23 used as the work area of CPU 25#.

Then, CPU 25# stores the processed and edited combined data in image memory 92.

By this process, as in Embodiment 1 described above, the designated write area similar to the designated write area displayed on display device 101 is ensured inside the outer frame area 160 on whiteboard 150.

By the arrangement described above, the designated write area is ensured on whiteboard 150, and it is possible for the user to execute handwriting to the designated write area.

By the method in accordance with the present embodiment, the designated write area is ensured and, therefore, if the distribution data is displayed on the entire area of whiteboard 150 and handwriting is to be made on whiteboard 150, it is possible to avoid confusion of the written contents caused by overlapping on the displayed image.

Further, by the method in accordance with the present embodiment, the designated write area is ensured and, therefore, the problem that handwriting at an appropriate position is impossible because of space limitation, for example, there is no space for handwriting or only a corner of an area is available as the space for handwriting, can be solved. Thus, user convenience is improved and more smooth progress of a conference becomes possible.

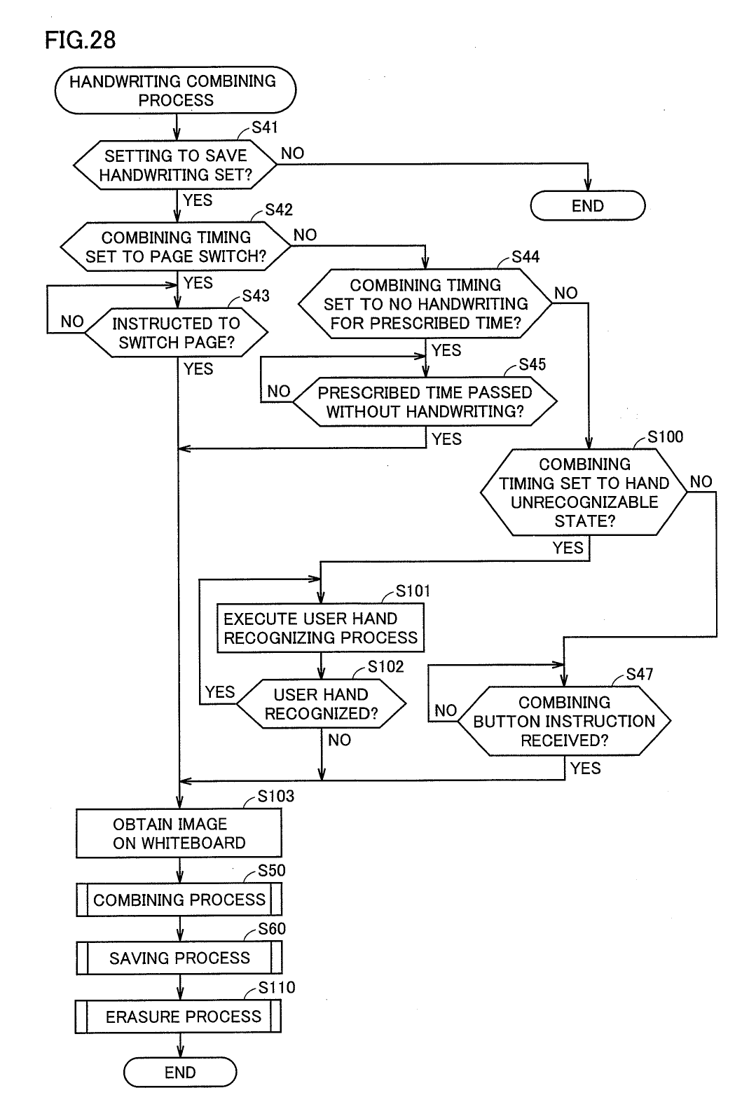

The handwriting combining process in accordance with Embodiment 2 of the present invention will be described with reference to FIG. 28.

Referring to FIG. 28, first, whether there is any setting for saving the handwriting is determined (step S41).

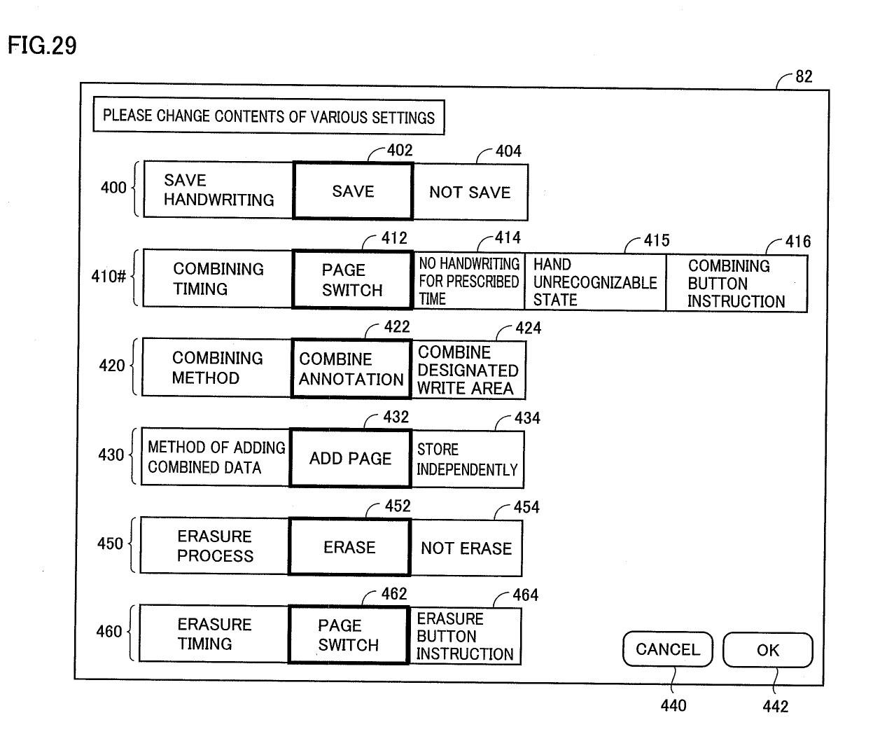

FIG. 29 shows a window for various settings, in accordance with Embodiment 2 of the present invention.

Specifically, when “TO SETTING WINDOW” button 312 is pressed on the window for confirming designated write area shown in FIG. 12, the display is switched to the window for various settings, executing various setting processes related to writing. It is also possible to provide “TO SETTING WINDOW” button 312 to enable transition to the window for various settings on a window other than the window for confirming designated write area shown in FIG. 12.

Referring to FIG. 29, by way of example, on display 82 of the operation panel, there is a display of “PLEASE CHANGE CONTENTS OF VARIOUS SETTINGS” and, an item 400 for setting handwriting saving, an item 410# for setting combining timing, an item 420 for setting combining method, an item 430 for setting a method of adding combined data, an item 450 for setting erasure process, and an item 460 for setting erasure timing are provided.

Here, the item 400 for setting handwriting saving, item 420 for setting combining method, item 430 for setting a method of adding combined data, item 450 for setting erasure process, and item 460 for setting erasure timing are the same as those of the window for various settings shown in FIG. 19 and, therefore, detailed description thereof will not be repeated.

If “PAGE SWITCH” button 412 of item 410# for setting combining timing is pressed, the combining timing is set at the page switch, as will be described later. Further, if “NO WRITING FOR PRESCRIBED TIME” button 414 is selected, the combining timing is set to when writing is not done for a prescribed time period. If “HAND UNRECOGNIZED” button 415 is selected, the combination timing is set to the state when the hand is once recognized and thereafter becomes unrecognizable. If “COMBINATION BUTTON INSTRUCTION” button 416 is selected, the combining timing is set to when there is an instruction of combination button.

Again referring to FIG. 28, if it is determined at step S41 that the setting for handwriting saving is not set, CPU 25# ends the process (END).

Specifically, on the window for various settings shown in FIG. 29, if “NOT SAVE” button 404 of item 400 for setting handwriting saving is selected and the setting of handwriting saving is not set, the process ends.

At step S41, if it is determined that setting for handwriting saving is set, specifically, if “SAVE” button 402 of item 400 for setting handwriting saving is selected and the setting of handwriting saving is set on the window for various settings shown in FIG. 29, CPU 25# next determines whether or not the combining timing is set to the page switch (step S42).

Specifically, on the window for various settings shown in FIG. 29, whether or not “PAGE SWITCH” button 412 of item 410# for setting combining timing is selected and the combining timing is set to the page switch is determined.

If it is determined at step S42 that the combining timing is set to the page switch, CPU 25# proceeds to step S43, at which whether there has been an input of page switch instruction is determined (step S43). If the page switch instruction is input at step S43, CPU 25# obtains the image on the whiteboard (step S103). Then, it executes the combining process (step S50).

If it is determined that the combining timing is not, set to the page switch at step S42, CPU 25# determines whether or not the combining timing is set to when there is no writing for a prescribed time (step S44).

Specifically, on the window for various settings shown in FIG. 29, whether or not “NO WRITING FOR PRESCRIBED TIME” button 414 of item 410# for setting combining timing is selected, and the combining timing is set to when there is no writing for a prescribed timing, is determined.

If it is determined at step S44 that the combining timing is set to when there is no writing for a prescribed time, CPU 25# proceeds to step S45, at which whether or not a prescribe time has passed without any writing is determined (step S45). Specifically, at step S90# of FIG. 27, after the combined data with the designated write area ensured is projected on the whiteboard by projector 12, the projected image displayed on the whiteboard is obtained by camera 14.

After the handwritten image to the designated write area is obtained, based on whether the handwriting is executed to the designated write area and thereby the handwritten image in the designated write area has been updated within a prescribed time period, it is possible to determine whether or not the prescribed time period has passed without any writing.

Specifically, the image displayed on the whiteboard is obtained by camera 14 and the picked-up image is stored in image memory 96, and CPU 25# can determine whether or not the picked-up image data stored in image memory 96 is updated within a prescribed time period.

If the picked-up image data stored in image memory 96 is not updated within the prescribed time period, CPU 25# can determine that the prescribed time period has passed without any writing.

If it is determined that the prescribed time period has passed without any writing at step S45, CPU 25# obtains the image on the whiteboard (step S103). Specifically, when the image displayed on the whiteboard is obtained by camera 14 and the picked-up image is stored in memory 96, if it is determined that the prescribed time period has passed without any writing, the data stored in image memory 96 is regarded as the last picked-up image data on the whiteboard. Then, the combining process is executed (step S50).

On the other hand, if it is determined at step S44 that the combining timing is not set to when there is no writing for a prescribed time period, CPU 25# determines whether the combining timing is set to the state in which one's hand becomes unrecognizable (step S100). Specifically, whether or not “HAND UNRECOGNIZED” button 415 of item 410# for setting combining timing on the window for various settings shown in FIG. 29 is selected and the combining timing is set to a state in which once recognized hand becomes unrecognizable, is determined.

If it is determined at step S100 that the combining timing is set to the state in which the hand becomes unrecognizable, CPU 25# executes a user hand recognizing process (step S101).

Specifically, a recognizing process is performed, in which the image displayed on the whiteboard is picked-up by camera 14, the picked-up image is stored in image memory 96, and whether or not the picked-up image stored in image memory 96 includes a hand is determined. By way of example, it is possible to execute the recognizing process for determining whether or not a hand is included, using pattern matching of a hand image data as the object of recognition.

Then, CPU 25# determines whether the user's hand is recognized or not (step S102). If the user's hand is recognized in the recognizing process, the process steps S101 and S102 are repeated. If CPU 25# determines at step S102 that the user's hand is no longer recognized, the control proceeds to step S103.

Then, the image on the whiteboard is obtained (step S103). Specifically, when the image displayed on the whiteboard is obtained by camera 14 and the picked-up image is stored in memory 96, if it is determined that the user's hand is no longer recognized, the data stored in image memory 96 is regarded as the last picked-up image data on the whiteboard. Then, the combining process is executed (step S50).

If it is determined at step S100 that the combining timing is not set to the state in which the hand becomes unrecognizable, CPU 25# determines whether there is a combination button instruction or not (step S47). The reason for this is that if the combining timing is not set to the page switch, not set to when there is no writing for a prescribed time period, nor to the state in which the hand becomes unrecognizable, it is possible to determine that the combining timing is set to when there is a combination button instruction.

If it is determined at step S47 that there is a combination button instruction, the image on the whiteboard is obtained (step S103). Specifically, if there is an instruction by the combination button, the instruction is used as a trigger, and the image displayed on the whiteboard is picked up by camera 14, and the data of picked-up image stored in image memory 96 is regarded as the last picked-up image data on the whiteboard. Then, the combining process is executed (step S50).

The combining process at step S50 and the saving process at step S60 are the same as those described with reference to FIGS. 20 and 22.

As to how the handwritten image data written to the designated write area is obtained, CPU 25# obtains the handwritten image data in the designated write area based on the difference between the data stored in image memory 92 and the image data included in the extracted outer frame area 160 of the picked-up image data stored in image memory 96, in the similar manner as described above.

By this method also, it is possible to add the combined data in which the write-data input to the designated write area is combined, and to confirm it.

By storing the combined data independently in HDD 26, is it also possible to access the stored combined data for later review.

Again referring to FIG. 28, next, the erasure process is executed (step S110). Then, the process ends (END).

The flow of erasure process at step S110 is the same as that described with reference to FIG. 24.

As the specific erasure process, CPU 25# instructs erasure device control signal output unit 24 to output a control signal instructing execution of erasure, to erasure device control unit 175.

Receiving an input of the control signal instructing execution of erasure output from erasure device control signal output unit 24, erasure device control unit 175 drives erasure device 170, and erases the image written to whiteboard 150.

By way of example, erasure device 170 moves on whiteboard 150 as the screen while it is in pressure contact therewith, and erases the image on the whiteboard that has been input by, for example, handwriting.

Specifically, by the method in accordance with Embodiment 2 of the present invention, after the write-data input to the designated write area on the whiteboard is combined, it is possible to add combined data and to confirm the same, and the handwritten image can automatically be erased by erasure device 170.

If the handwritten image on the whiteboard is left as it is, it may be overlapped on the image of the next page, possibly causing confusion. Therefore, before executing an instruction to switch to the next page, it is necessary for the user, for example, to manually erase the image written in the designated write area on the whiteboard. According to the method of Embodiment 2, such a complicated work becomes unnecessary, improving convenience for the user.

As the recovery process, CPU 25# stores the distribution data stored in image memory 94 to image memory 92. This results in a display of image 200, which is the same as that described with reference to FIG. 8 to which the handwriting is not yet executed on whiteboard 150.

Therefore, by the recovery before execution of the handwriting, it becomes possible to restore the original state, improving convenience for the user and enabling more smooth progress of a conference.

In Embodiment 2 of the present invention, an example has been described in which the picked-up image data picked-up by camera 14 is output to picked-up image obtaining unit 31. In place of camera 14, a scanner unit may be provided on whiteboard 150, and the read image data obtained by reading the image handwritten on the whiteboard may be output to picked-up image obtaining unit 31.

In the embodiments of the present invention, a method in which distribution data stored in HDD 26 of MFP 10 or 10# is displayed on the display device, or projected on the screen by a projector has been described. MFP is not limiting, and the invention may be applicable to a PC, a printer or the like. Further, not the distribution data stored in HDD 26 but stored in other storage unit may be used. By way of example, it is naturally possible to distribute data stored in flash memory 30 shown in FIG. 3.

Further, in the embodiments, a structure has been described in which remote controller 45 and remote control detecting unit 35 are provided, allowing operation instruction such as page switching by the operation of remote controller. Provision of remote controller 45 and remote control detecting unit 35 is not limiting, and all operation instructions may be given through operation panel 80.

Further, a program that causes a computer to realize the conference system in accordance with the present invention as described above, to execute control such as represented by the flowchart above, may be provided. Such a program may be provided as a program product recorded on a computer readable recording medium such as a flexible disk, a CD-ROM (Compact Disk-Read Only Memory), an ROM (Read Only Memory), an RAM (Random Access Memory) or a memory card related to a computer. Alternatively, the program may be provided recorded on a recording medium such as a hard disk provided inside a computer. Further, the program may be provided down-loaded from a network.

The program may be provided by calling necessary ones of program modules provided as a part of an operation system (OS) of a computer, in a prescribed sequence at a prescribed timing and executing the same. In that case, the program itself does not include such modules, and the process is executed in cooperation with the OS. The program not including such modules is also encompassed by the present invention.

The program may be provided incorporated as a part of another program. In that case also, the program itself does not include such modules included in the other program as described above, and the process is executed in cooperation with the other program. Such a program incorporated in another program is also encompassed by the present invention.

The provided program product is executed installed in a program storage such as the hard disk. The program product includes the program itself and a recording medium recording the program.

Although the present invention has been described and illustrated in detail, it is clearly understood that the same is by way of illustration and example only and is not to be taken by way of limitation, the scope of the present invention being interpreted by the terms of the appended claims.

What is claimed is:

1. A data distribution system, comprising:
a data distribution apparatus outputting distribution data; and
a display device displaying the distribution data output from said data distribution apparatus; wherein
said data distribution apparatus includes
an input device receiving coordinate data input corresponding to a designated position of input, in a display area of said display device, and
a controller configured to control said data distribution apparatus for
i) outputting first handwritten image data to said display device such that based on the coordinate data of which input is received by said input device, the handwritten image is displayed in the display area of said display device,
ii) determining whether a partial area in said display area of said display device is designated, based on said first handwritten image data, and
iii) if it is determined that partial area in the display area of said display device is designated, editing said distribution data to ensure said designated partial area as a handwriting area, and outputs the data to said display device.

2. A data distribution apparatus for outputting distribution data to be displayed on a display device, comprising:
an input device receiving coordinate data input corresponding to a designated position of input, in a display area of said display device, and
a controller configured to control said data distribution apparatus for
i) outputting first handwritten image data to said display device such that based on the coordinate data of which input is received by said input device, the handwritten image is displayed in the display area of said display device,
ii) determining whether a partial area in said display area of said display device is designated, based on said first handwritten image data, and
iii) if it is determined that partial area in the display area of said display device is designated, editing said distribution data to ensure said designated partial area as a handwriting area, and outputs the data to said display device.

3. The data distribution apparatus according to claim 2, wherein
said controller determines whether said first handwritten image data is data representing an area surrounded by a handwritten line in the display area of said display device.

4. The data distribution apparatus according to claim 3, wherein
if it is determined that said first handwritten image data is data representing an area surrounded by a handwritten line in the display area of said display device, said controller edits said distribution data to have inside or outside of the area surrounded by the handwritten line as handwriting area image data, and outputs to said display device.

5. The data distribution apparatus according to claim 2, wherein
said controller determines whether said first handwritten image data is data representing a plurality of points surrounding an area in the display area of said display device.

6. The data distribution apparatus according to claim 5, wherein
if it is determined that said first handwritten image data is data representing a plurality of points surrounding an area in the display area of said display device, said controller edits said distribution data to have inside or outside of the area surrounded by the plurality of points as handwriting area image data, and outputs to said display device.

7. The data distribution apparatus according to claim 2, wherein
said display device is provided with a touch panel; and
said input device receives input of coordinate data corresponding to a designated position of input from said touch panel.

8. The data distribution apparatus according to claim 2, wherein
if it is determined that a partial area in said display area of said display device is designated, based on said first handwritten image data, said controller displays in advance an image to be displayed on said display device after editing of said distribution data, on an operation window.

9. The data distribution apparatus according to claim 2, wherein
said controller performs a combining process of combining said distribution data with handwriting area image data in which nothing is displayed in said designated partial area in the display area of said display device, and outputs combined data to said display device.

10. The data distribution apparatus according to claim 2, wherein
said controller performs a combining process of combining said distribution data with handwriting area image data in which said designated partial area in the display area of said display device becomes an area of a prescribed color, and outputs combined data to said display device.

11. The data distribution apparatus according to claim 2, wherein
said controller reduces and outputs to said display device said distribution data such that the data is contained in an area outside said designated partial area in the display area of said display device.

12. The data distribution apparatus according to claim 2, wherein
said controller displays on an operation window a candidate selection image allowing selection from a plurality of handwriting area image data,
receives an input to select one of said plurality of handwriting area image data displayed on said candidate selection image, and
performs a combining process of combining said distribution data with said selected handwriting area image data and outputs combined data to said display device.

13. The data distribution device according to claim 2, wherein
said controller combines said distribution data with second handwritten image data such that the handwritten image is displayed in said handwriting area ensured in said display device.

14. The data distribution apparatus according to claim 13, wherein
said controller performs a combining process such that said second handwritten image data is displayed in the designated partial area in the display area of said display device and said distribution data reduced in size is displayed in an area outside of said designated partial area.

15. The data distribution apparatus according to claim 13, wherein
said controller performs a combining process such that said second handwritten image data is displayed in the designated partial area in the display area of said display device, and, of the distribution data displayed in the display area of said display device, said distribution data corresponding to an area outside of said designated partial area is displayed.

16. The data distribution apparatus according to claim 13, wherein
said distribution data includes a plurality of page data separated page by page and distributed in turn; and
said controller performs the combining process of combining said page data with said second handwritten image data.

17. The data distribution apparatus according to claim 13, wherein
said distribution data includes a plurality of page data separated page by page and distributed in turn; and
said controller performs the combining process of combining said page data with said second handwritten image data, in response to an instruction to switch page data to be distributed.

18. The data distribution apparatus according to claim 13, wherein
if it is determined that after said second handwritten image data is output, there is no handwriting made to said handwriting area ensured in said display device for a prescribed time period, said controller performs a combining process of combining said distribution data with said second handwritten image data.

19. A data distribution system, comprising:
a data distribution apparatus outputting distribution data;
a projector device projecting the distribution data output from said distribution apparatus to a screen; and
an image pick-up device obtaining an image displayed on said screen; wherein
said data distribution apparatus includes a controller configured to control said distribution apparatus for
i) extracting, based on an image obtained by picking-up the image displayed on said screen by said image pick-up device, an image handwritten to said screen included in an area projected to said screen,
ii) determining, based on said extracted handwritten image data written to said screen, whether a partial area of said distribution data projected on said screen is designated, and
iii) if it is determined that a partial area of said distribution data projected on said screen is designated, editing said distribution data and outputs to said projector device, to ensure said designated partial area as a handwriting area.

20. A data distribution apparatus outputting distribution data to be projected on a screen to a projector device, comprising:
a controller configured to control said data distribution apparatus for
i) extracting, based on an image obtained by picking-up the image displayed on said screen, an image handwritten to said screen included in an area projected to said screen as a first handwritten image,
ii) determining, based on said extracted first handwritten image data written to said screen, whether a partial area of said distribution data projected on said screen is designated, and
iii) if it is determined that a partial area of said distribution data projected on said screen is designated, editing said distribution data and outputs to said projector device, to ensure said designated partial area as a handwriting area.

21. The data distribution apparatus according to claim 20, wherein
said controller determines whether said first handwritten image data represents an area surrounded by a handwritten line.

22. The data distribution apparatus according to claim 21, wherein
if it is determined that said first handwritten image data is data representing an area surrounded by a handwritten line in an area of said screen on which said distribution data is projected, said controller edits said distribution data to have inside or outside of the area surrounded by the handwritten line as handwriting area image data, and outputs to said projector device.

23. The data distribution apparatus according to claim 20, wherein
said controller determines whether said first handwritten image data is data representing a plurality of points surrounding an area in the area of said screen on which said distribution data is projected.

24. The data distribution apparatus according to claim 23, wherein
if it is determined that said first handwritten image data is data representing a plurality of points surrounding an area in the area of said screen on which said distribution data is projected, said controller edits distribution data to have inside or outside of the area surrounded by the plurality of points as handwriting area image data, and outputs to said projector device.

25. The data distribution apparatus according to claim 20, wherein
said data distribution apparatus receives as an input an image obtained by a camera or a scanner.

26. The data distribution apparatus according to claim 20, wherein
if it is determined that said partial area is designated, said controller displays in advance an image to be projected to said screen by said projector device after editing of said distribution data, on an operation window.

27. The data distribution apparatus according to claim 20, wherein
said controller performs a combining process of combining said distribution data with handwriting area image data in which nothing is displayed in said designated partial area in the area of said screen on which said distribution data is projected, and outputs combined data to said display device.

28. The distribution apparatus according to claim 20, wherein
said controller performs a combining process of combining said distribution data with a handwriting area image data in which said designated partial area in the area of said screen on which said distribution data is projected becomes an area of a prescribed color, and outputs combined data to said display device.

29. The data distribution apparatus according to claim 28, wherein
said area of a prescribed color has the same color as said screen.

30. The data distribution apparatus according to claim 20, wherein
said controller reduces and outputs to said display device said distribution data such that the data is contained in an area outside said designated partial area in the area of said screen on which said distribution data is projected.

31. The data distribution apparatus according to claim 20, wherein
said controller displays on an operation window a candidate selection image allowing selection from a plurality of handwriting area image data,
receives an input to select one of said plurality of handwriting area image data displayed on said candidate selection image, and
performs a combining process of combining said distribution data with said selected handwriting area image data and outputs combined data to said projector device.

32. The data distribution apparatus according to claim 20, wherein
after said handwriting area is ensured on said screen, said data distribution apparatus receives as an input another image obtained by picking-up an image displayed on said screen; and
said controller extracts, based on said another obtained image, an image handwritten to said handwriting area of said screen, and
combines said distribution data with second handwritten image data written to said extracted handwriting area of said screen.

33. The data distribution apparatus according to claim 32, wherein
said controller performs a combining process such that said second handwritten image data is displayed in the designated partial area and said distribution data reduced in size is displayed in an area outside of said designated partial area.

34. The data distribution apparatus according to claim 32, wherein
said controller performs a combining process such that said second handwritten image data is displayed in the designated partial area, and, of the distribution data displayed in the display area of said display device, said distribution data corresponding to an area outside of said designated partial area is displayed.

35. The data distribution apparatus according to claim 32, wherein
said distribution data includes a plurality of page data separated page by page and distributed in turn; and
said controller performs the combining process of combining said page data with said extracted second handwritten image data.

36. The data distribution apparatus according to claim 32, wherein
said distribution data includes a plurality of page data separated page by page and distributed in turn; and
said controller performs the combining process of combining said page data with said extracted second handwritten image data, in response to an instruction to switch page data to be distributed.

37. The data distribution apparatus according to claim 32, wherein
if it is determined that after said second handwritten image data written to said screen is extracted, there is no extraction of another handwritten image data written to said handwriting area for a prescribed time period, said controller performs a combining process of combining said distribution data with said second handwritten image data.

38. The data distribution apparatus according to claim 32, wherein
based on said another obtained image, said controller recognizes a person's hand performing a handwriting, in a range of image pickup between said projector device and said screen, and
if a person's hand is recognized, said controller combines the distribution data with the second handwritten image data written to said handwriting area of said screen.

39. The data distribution apparatus according to claim 20, wherein
said controller further controls an erasure device for erasing an image handwritten to said screen, provided on said screen.

40. The data distribution apparatus according to claim 39, wherein
said distribution data includes a plurality of page data separated page by page and distributed in turn; and
said controller instructs said erasure device to erase an image handwritten to said screen in response to an instruction to switch page data to be distributed.

41. A data distribution method of distributing data to be displayed to a display device, comprising the steps of:
receiving coordinate data input corresponding to a designated position of input, in a display area of said display device;
outputting first handwritten image data to said display device such that based on the coordinate data of which input is received, the handwritten image is displayed in the display area of said display device;
determining whether a partial area in said display area of said display device is designated, based on said first handwritten image data; and
if it is determined at said determining step that partial area in the display area of said display device is designated, editing said distribution data to ensure said designated partial area as a handwriting area, and outputting the data to said display device.

42. A recording medium recording a data distribution program to be executed by a computer of a data distribution apparatus outputting distribution data to be displayed on a display device,
said data distribution program causing the computer to execute the steps of:
receiving coordinate data input corresponding to a designated position of input, in a display area of said display device;
outputting first handwritten image data to said display device such that based on the coordinate data of which input is received, the handwritten image is displayed in the display area of said display device;
determining whether a partial area in said display area of said display device is designated, based on said first handwritten image data; and
if it is determined at said determining step that partial area in the display area of said display device is designated, editing said distribution data to ensure said designated partial area as a handwriting area, and outputting the data to said display device.

43. A data distribution method of distributing data to be projected on a screen to a projector device, comprising the steps of:
extracting, based on an image obtained by picking-up the image displayed on said screen, an image handwritten to said screen included in an area projected to said screen;
determining, based on said extracted handwritten image data written to said screen, whether a partial area of said distribution data projected on said screen is designated; and
if it is determined at said determining step that a partial area of said distribution data projected on said screen is designated, editing said distribution data and outputting to said projector device, to ensure said designated partial area as a handwriting area.

44. A recording medium recording a data distribution program to be executed by a computer of a data distribution apparatus outputting distribution data to be projected on a screen to a projector device,
said data distribution program causing the computer to execute the steps of:
extracting, based on an image obtained by picking-up the image displayed on said screen, an image handwritten to said screen included in an area projected to said screen;
determining, based on said extracted handwritten image data written to said screen, whether a partial area of said distribution data projected on said screen is designated; and
if it is determined at said determining step that a partial area of said distribution data projected on said screen is designated, editing said distribution data and outputting to said projector device, to ensure said designated partial area as a handwriting area.
